(19) United States
(12) Patent Application Publication
(10) Pub. No.: US 2024/0114312 A1
(43) Pub. Date: Apr. 4, 2024

(54) RENDERING INTERFACE FOR AUDIO DATA IN EXTENDED REALITY SYSTEMS

(71) Applicant: QUALCOMM Incorporated, San Diego, CA (US)

(72) Inventors: Imed Bouazizi, Frisco, TX (US); Thomas Stockhammer, Bergen (DE); Isaac Garcia Munoz, San Diego, CA (US); Nikolai Konrad Leung, San Francisco, CA (US); Andre Schevciw, San Diego, CA (US); Graham Bradley Davis, Seattle, WA (US)

(21) Appl. No.: 18/467,869

(22) Filed: Sep. 15, 2023

Related U.S. Application Data
(60) Provisional application No. 63/377,169, filed on Sep. 26, 2022.
(60) Provisional application No. 63/578,618, filed on Aug. 24, 2023.

(51) Int. Cl. H04S 7/00; G06T 15/00; G06T 19/20; H04R 5/02; H04S 3/00

(52) U.S. Cl. CPC H04S 7/304; G06T 15/005; G06T 19/20; H04R 5/02; H04S 3/008; G06T 2210/61; G06T 2219/2016; H04R 5/033; H04R 2499/15; H04S 2400/11

(57) ABSTRACT

A device configured to process a bitstream may implement the techniques. The device comprises a memory configured to store the bitstream representative of at least one audio element in an extended reality scene, and audio descriptive information associated with the at least one audio element. The device also comprises processing circuitry coupled to the memory and configured to execute a scene manager and an audio unit. The scene manager is configured to construct, based on the at least one audio element, a scene graph that includes at least one node that represents the at least one audio element, and modify, based on the scene graph, the audio descriptive information to obtain modified audio descriptive information. The audio unit is configured to render, based on the modified audio descriptive information, the at least one audio element to one or more speaker feeds, and output the one or more speaker feeds.

This application claims the benefit of U.S. Provisional Application Ser. No. 63/377,169, entitled “RENDERING INTERFACE FOR AUDIO DATA IN EXTENDED REALITY SYSTEMS,” filed Sep. 26, 2022, and U.S. Provisional Application Ser. No. 63/578,618, entitled “RENDERING INTERFACE FOR AUDIO DATA IN EXTENDED REALITY SYSTEMS,” filed Aug. 24, 2023, the entire contents of each of which is hereby incorporated by reference.

### TECHNICAL FIELD

This disclosure relates to processing of audio data.

### BACKGROUND

Computer-mediated reality systems are being developed to allow computing devices to augment or add to, remove or subtract from, or generally modify existing reality experienced by a user. Computer-mediated reality systems (which may also be referred to as “extended reality systems,” or “XR systems”) may include, as examples, virtual reality (VR) systems, augmented reality (AR) systems, and mixed reality (MR) systems. The perceived success of computer-mediated reality systems are generally related to the ability of such computer-mediated reality systems to provide a realistically immersive experience in terms of both the visual and audio experience where the visual and audio experience align in ways expected by the user. Although the human visual system is more sensitive than the human auditory systems (e.g., in terms of perceived localization of various objects within the scene), ensuring an adequate auditory experience is an increasingly import factor in ensuring a realistically immersive experience, particularly as the visual experience improves to permit better localization of visual objects that enable the user to better identify sources of audio content.

### SUMMARY

This disclosure generally relates to techniques for providing a separate audio interface that facilitates rendering at the audio playback system. The techniques may enable an audio playback system to synchronize playback of audio elements to playback of visual elements. The audio playback system may include an interface (such as an application programming interface—API) that an audio system may expose in order to facilitate interactions with a scene manager that manages playback of one or more visual elements that support an extended reality (XR) scene.

In some instances, the audio elements may not be captured at the same time as the visual elements or may be added later (e.g., during a XR mediated conference, such as an XR videoconference). As such, the audio playback system may invoke the scene manager to match one or more visual elements to one or more audio elements (e.g., by comparing a name or other unique identifier—UID—associated with each of the one or more visual elements and one or more audio elements). The scene manager may modify audio metadata defining a pose (which may refer to a position and/or orientation) of the one or more audio elements to more closely correspond to the matching one or more visual elements. The scene manager may then output the modified audio metadata to an audio unit of the audio playback system, which may render the audio elements to one or more speaker feeds. The audio playback system may then output the one or more speaker feeds to one or more speakers (which may also be referred to as loudspeakers, headphone speakers, or more generally as transducers).

As such, the techniques may improve operation of the audio playback system as the audio playback system may more accurately reproduce a soundfield (based on the one or more speaker feeds) to potentially improve the immersive experience of XR systems. That is, rather than render the audio elements based on low resolution audio metadata that may not match the corresponding visual element, the audio playback system may modify the audio metadata to more closely match the corresponding visual element, thereby increasing the immersion of the XR experience through higher resolution audio metadata. As such, various aspects of the techniques described in this disclosure may improve the audio playback system itself.

In one example, the techniques are directed to a device configured to process an audio bitstream, the device comprising: a memory configured to store a visual bitstream representative of at least one visual element in an extended reality scene and the audio bitstream representative of at least one audio element in the extended reality scene; and processing circuitry coupled of the memory and configured to: map, based on visual metadata associated with the at least one visual element and audio metadata associated with the at least one audio element, the at least one visual element to the at least one audio element; modify, based on the mapping of the at least one visual element to the at least one audio element, the audio metadata to obtain modified audio metadata; render, based on the modified audio metadata, the at least one audio element to one or more speaker feeds; and output the one or more speaker feeds.

In another example, the techniques are directed to a method of processing at least one audio element, the method comprising: mapping, based on visual metadata associated with at least one visual element and audio metadata associated with the at least one audio element, the at least one visual element to the at least one audio element; modifying, based on the mapping of the at least one visual element to the at least one audio element, the audio metadata to obtain modified audio metadata; rendering, based on the modified audio metadata, the at least one audio element to one or more speaker feeds; and outputting the one or more speaker feeds.

In another example, the techniques are directed to a non-transitory computer-readable storage medium having instructions stored thereon that, when executed, cause one or more processors to: map, based on visual metadata associated with the at least one visual element and audio metadata associated with the at least one audio element, the at least one visual element to the at least one audio element; modify, based on the mapped of the at least one visual element to the at least one audio element, the audio metadata to obtain modified audio metadata; render, based on the modified audio metadata, the at least one audio element to one or more speaker feeds; and output the one or more speaker feeds.

In another example, the techniques are directed to a device configured to process an audio bitstream, the device comprising: a memory configured to store a visual bitstream representative of at least one visual element in an extended reality scene and the audio bitstream representative of at least one audio element in the extended reality scene; and processing circuitry coupled of the memory and configured to execute a scene manager and an audio unit, wherein the scene manager is configured to: map, based on visual metadata associated with the at least one visual element and audio metadata associated with the at least one audio element, the at least one visual element to the at least one audio element; modify, based on the mapping of the at least one visual element to the at least one audio element, the audio metadata to obtain modified audio metadata; and register, with the audio unit, a callback by which the audio unit is configured to request the modified audio metadata prior to rendering the at least one audio element, and wherein the audio unit is configured to: render, based on the modified audio metadata, the at least one audio element to one or more speaker feeds; and output the one or more speaker feeds.

In another example, the techniques are directed to a method of processing at least one audio element, the method comprising: mapping, by a scene manager executed by processing circuitry and based on visual metadata associated with at least one visual element and audio metadata associated with the at least one audio element, the at least one visual element to the at least one audio element; modifying, by the scene manager and based on the mapping of the at least one visual element to the at least one audio element, the audio metadata to obtain modified audio metadata; rendering, by an audio unit executed by the processing circuitry and based on the modified audio metadata, the at least one audio element to one or more speaker feeds; and outputting, by the audio unit, the one or more speaker feeds.

In another example, the techniques are directed to a non-transitory computer-readable storage medium having instructions stored thereon that, when executed, cause one or more processors to: execute a scene manager configured to: map, based on visual metadata associated with the at least one visual element and audio metadata associated with the at least one audio element, the at least one visual element to the at least one audio element; and modify, based on the mapping of the at least one visual element to the at least one audio element, the audio metadata to obtain modified audio metadata; and execute an audio unit configured to: render, based on the modified audio metadata, the at least one audio element to one or more speaker feeds; and output the one or more speaker feeds.

In another example, the techniques are directed to a device configured to process an audio bitstream, the device comprising: a memory configured to store a visual bitstream representative of at least one visual element in an extended reality scene and the audio bitstream representative of at least one audio element in the extended reality scene; and processing circuitry coupled of the memory and configured to execute a scene manager, an audio processing unit, and an audio unit, wherein the scene manager is configured to: map, based on visual metadata associated with the at least one visual element and audio metadata associated with the at least one audio element, the at least one visual element to the at least one audio element; modify, based on the mapping of the at least one visual element to the at least one audio element, the audio metadata to obtain modified audio metadata; and configure the audio processing unit to modify, based on the mapping of the at least one visual element to the at least one audio element, the audio metadata to obtain the modified audio metadata, wherein the audio processing unit is configured to: replace, based on the configuration, the audio metadata in the audio bitstream with the modified audio metadata; and output the audio bitstream to the audio unit, and wherein the audio unit is configured to: render, based on the modified audio metadata, the at least one audio element to one or more speaker feeds; and output the one or more speaker feeds.

In another example, the techniques are directed to a method of processing at least one audio element, the method comprising: mapping, by a scene manager executed by processing circuitry and based on visual metadata associated with at least one visual element and audio metadata associated with the at least one audio element, the at least one visual element to the at least one audio element; modifying, by the scene manager and based on the mapping of the at least one visual element to the at least one audio element, the audio metadata to obtain modified audio metadata; configuring, by the scene manager, an audio processing unit to modify, based on the mapping of the at least one visual element to the at least one audio element, the audio metadata to obtain the modified audio metadata, replacing, by the audio processing unit and based on the configuration, the audio metadata in the audio bitstream with the modified audio metadata; and outputting, by the audio processing unit, the audio bitstream to an audio unit executed by the processing circuitry; rendering, by the audio unit and based on the modified audio metadata, the at least one audio element to one or more speaker feeds; and outputting, by the audio unit, the one or more speaker feeds.

In another example, the techniques are directed to a non-transitory computer-readable storage medium having instructions stored thereon that, when executed, cause one or more processors to: execute a scene manager configured to map, based on visual metadata associated with the at least one visual element and audio metadata associated with the at least one audio element, the at least one visual element to the at least one audio element, and modify, based on the mapping of the at least one visual element to the at least one audio element, the audio metadata to obtain modified audio metadata, and configure an audio processing unit to modify, based on the mapping of the at least one visual element to the at least one audio element, the audio metadata to obtain the modified audio metadata; execute the audio processing unit to replace, based on the configuration, the audio metadata in the audio bitstream with the modified audio metadata, and output the audio bitstream to the audio unit; and execute an audio unit configured to render, based on the modified audio metadata, the at least one audio element to one or more speaker feeds, and output the one or more speaker feeds.

In another example, the techniques are directed to a device configured to process an audio bitstream, the device comprising: a memory configured to store a visual bitstream representative of at least one visual element in an extended reality scene and the audio bitstream representative of at least one audio element in the extended reality scene; and processing circuitry coupled of the memory and configured to execute a scene manager and an audio unit, wherein the scene manager is configured to: map, based on visual metadata associated with the at least one visual element and audio metadata associated with the at least one audio element, the at least one visual element to the at least one audio element; construct, based on the mapping of the at least one visual element to the at least one audio element, a scene graph that includes a parent node representative of the at least one visual element, and a child node that depends from the parent node and that represents the at least one audio element; and modify, based on the scene graph, the audio metadata to obtain modified audio metadata, and wherein the audio unit is configured to: render, based on the modified audio metadata, the at least one audio element to one or more speaker feeds; and output the one or more speaker feeds.

In another example, the techniques are directed to a method of processing at least one audio element, the method comprising: mapping, by a scene manager executed by processing circuitry and based on visual metadata associated with at least one visual element and audio metadata associated with the at least one audio element, the at least one visual element to the at least one audio element; constructing, by the scene manager and based on the mapping of the at least one visual element to the at least one audio element, a scene graph that includes a parent node representative of the at least one visual element, and a child node that depends from the parent node and that represents the at least one audio element; modifying, by the scene manager and based on the scene graph, the audio metadata to obtain modified audio metadata; rendering, by an audio unit executed by the processing circuitry and based on the modified audio metadata, the at least one audio element to one or more speaker feeds; and outputting, by the audio unit, the one or more speaker feeds.

In another example, the techniques are directed to a non-transitory computer-readable storage medium having instructions stored thereon that, when executed, cause one or more processors to: execute a scene manager configured to: map, based on visual metadata associated with the at least one visual element and audio metadata associated with the at least one audio element, the at least one visual element to the at least one audio element; construct, by the scene manager and based on the mapping of the at least one visual element to the at least one audio element, a scene graph that includes a parent node representative of the at least one visual element, and a child node that depends from the parent node and that represents the at least one audio element; and modify, by the scene manager and based on the scene graph, the audio metadata to obtain modified audio metadata; and execute an audio unit configured to: render, based on the modified audio metadata, the at least one audio element to one or more speaker feeds; and output the one or more speaker feeds.

In another example, the techniques are directed to a device configured to process a bitstream, the device comprising: a memory configured to store the bitstream representative of at least one audio element in the extended reality scene, and audio descriptive information associated with the at least one audio element; and processing circuitry coupled of the memory and configured to execute a scene manager and an audio unit, wherein the scene manager is configured to: construct, based on the at least one audio element, a scene graph that includes at least one node that represents the at least one audio element; and modify, based on the scene graph, the audio descriptive information to obtain modified audio descriptive information, and wherein the audio unit is configured to: render, based on the modified audio descriptive information, the at least one audio element to one or more speaker feeds; and output the one or more speaker feeds.

In another example, the techniques are directed to a method comprising: obtaining a bitstream representative of at least one audio element in an extended reality scene, and audio descriptive information associated with the at least one audio element; and constructing, based on the at least one audio element, a scene graph that includes at least one node that represents the at least one audio element; and modifying, based on the scene graph, the audio descriptive information to obtain modified audio descriptive information, and rendering, based on the modified audio descriptive information, the at least one audio element to one or more speaker feeds; and outputting the one or more speaker feeds.

In another example, the techniques are directed to a non-transitory computer-readable medium having stored thereon instructions that, when executed, cause processing circuitry to: obtain a bitstream representative of at least one audio element in an extended reality scene, and audio descriptive information associated with the at least one audio element; and construct, based on the at least one audio element, a scene graph that includes at least one node that represents the at least one audio element; and modify, based on the scene graph, the audio descriptive information to obtain modified audio descriptive information, and render, based on the modified audio descriptive information, the at least one audio element to one or more speaker feeds; and output the one or more speaker feeds.

The details of one or more examples of this disclosure are set forth in the accompanying drawings and the description below. Other features, objects, and advantages of various aspects of the techniques will be apparent from the description and drawings, and from the claims.

### BRIEF DESCRIPTION OF DRAWINGS

FIGS. 1A and 1B are diagrams illustrating systems that may perform various aspects of the techniques described in this disclosure.

FIGS. 2-4 are block diagrams illustrating example architectures of the playback system shown in the example of FIGS. 1A and/or 1B for performing various aspects of the audio rendering techniques described in this disclosure.

FIGS. 5A and 5B are diagrams illustrating examples of XR devices.

FIG. 6 illustrates an example of a wireless communications system that supports audio streaming in accordance with aspects of the present disclosure.

FIGS. 7 is a block diagram illustrating example architectures of the playback system shown in the example of FIGS. 1A and/or 1B for performing various aspects of the audio rendering techniques described in this disclosure.

FIG. 8 is a diagram illustrating an example of the audio playback system in performing a graph update in accordance with various aspects of the techniques described in this disclosure.

FIG. 9 is a diagram illustrating example listener space descriptor file (LSDF) alignment according to various aspects of the techniques described in this disclosure.

FIG. 10 is a flowchart illustrating example operation of the content consumer device of FIG. 1 in performing various aspects of the techniques described in this disclosure.

FIG. 11 is a table illustrating example functions provided by an application programming interface exposed by the audio unit shown in FIG. 7 in accordance with various aspects of the techniques described in this disclosure.

### DETAILED DESCRIPTION

There are a number of different ways to represent a soundfield. Example formats include channel-based audio formats, object-based audio formats, and scene-based audio formats. Channel-based audio formats refer to the 5.1 surround sound format, 7.1 surround sound formats, 22.2 surround sound formats, or any other channel-based format that localizes audio channels to particular locations around the listener in order to recreate a soundfield.

Object-based audio formats may refer to formats in which audio objects, often encoded using pulse-code modulation (PCM) and referred to as PCM audio objects, are specified in order to represent the soundfield. Such audio objects may include metadata identifying a location of the audio object relative to a listener or other point of reference in the soundfield, such that the audio object may be rendered to one or more speaker channels for playback in an effort to recreate the soundfield. The techniques described in this disclosure may apply to any of the foregoing formats, including scene-based audio formats, channel-based audio formats, object-based audio formats, or any combination thereof

Scene-based audio formats may include a hierarchical set of elements that define the soundfield in three dimensions. One example of a hierarchical set of elements is a set of spherical harmonic coefficients (SHC). The following expression demonstrates a description or representation of a soundfield using SHC:

$${p}_{i} ( t , {r}_{r} , {θ}_{r} , {φ}_{r} ) = {\sum }_{ω = 0}^{∞} [ 4 π {\sum }_{n = 0}^{∞} {j}_{n} ( k {r}_{r} ) {\sum }_{m = - n}^{n} {A}_{n}^{m} ( k ) {Y}_{n}^{m} ( {θ}_{r} , {φ}_{r} ) ] {e}^{j ω t} ,$$

The expression shows that the pressure pᵢ at any point {rᵣ, θᵣ, φᵣ} of the soundfield, at time t, can be represented uniquely by the SHC, Aₙ^{m}(k). Here,

$$k = \frac{ω}{c} ,$$

c is the speed of sound (˜343 m/s), {rᵣ, θᵣ, φᵣ} is a point of reference (or observation point), jₙ(·) is the spherical Bessel function of order n, and Yₙ^{m}(θᵣ, φᵣ) are the spherical harmonic basis functions (which may also be referred to as a spherical basis function) of order n and suborder m. It can be recognized that the term in square brackets is a frequency-domain representation of the signal (i.e., S(ω, rᵣ, θᵣ, φᵣ)) which can be approximated by various time-frequency transformations, such as the discrete Fourier transform (DFT), the discrete cosine transform (DCT), or a wavelet transform. Other examples of hierarchical sets include sets of wavelet transform coefficients and other sets of coefficients of multiresolution basis functions.

The SHC Aₙ^{m}(k) can either be physically acquired (e.g., recorded) by various microphone array configurations or, alternatively, they can be derived from channel-based or object-based descriptions of the soundfield. The SHC (which also may be referred to as ambisonic coefficients) represent scene-based audio, where the SHC may be input to an audio encoder to obtain encoded SHC that may promote more efficient transmission or storage. For example, a fourth-order representation involving (1+4)² (25, and hence fourth order) coefficients may be used.

As noted above, the SHC may be derived from a microphone recording using a microphone array. Various examples of how SHC may be physically acquired from microphone arrays are described in Poletti, M., “Three-Dimensional Surround Sound Systems Based on Spherical Harmonics,” J. Audio Eng. Soc., Vol. 53, No. 11, 2005 November, pp. 1004-1025.

The following equation may illustrate how the SHCs may be derived from an object-based description. The coefficients Aₙ^{m}(k) for the soundfield corresponding to an individual audio object may be expressed as:

Aₙ^{m}(k)=g(ω)(−4πik)hₙ⁽²⁾(krₛ)Yₙ^{m*}(θₛ, φₛ),

where i is \sqrt{−1},hₙ⁽²⁾(·) is the spherical Hankel function (of the second kind) of order n, and {rₛ, θₛ, φₛ} is the location of the object. Knowing the object source energy g(ω) as a function of frequency (e.g., using time-frequency analysis techniques, such as performing a fast Fourier transform on the pulse code modulated—PCM—stream) may enable conversion of each PCM object and the corresponding location into the SHC Aₙ^{m}(k). Further, it can be shown (since the above is a linear and orthogonal decomposition) that the Aₙ^{m}(k) coefficients for each object are additive. In this manner, a number of PCM objects can be represented by the Aₙ^{m}(k) coefficients (e.g., as a sum of the coefficient vectors for the individual objects). The coefficients may contain information about the soundfield (the pressure as a function of 3D coordinates), and the above represents the transformation from individual objects to a representation of the overall soundfield, in the vicinity of the observation point {rᵣ, θᵣ, φᵣ}.

Computer-mediated reality systems (which may also be referred to as “extended reality systems,” or “XR systems”) are being developed to take advantage of many of the potential benefits provided by ambisonic coefficients. For example, ambisonic coefficients may represent a soundfield in three dimensions in a manner that potentially enables accurate three-dimensional (3D) localization of sound sources within the soundfield. As such, XR devices may render the ambisonic coefficients to speaker feeds that, when played via one or more speakers, accurately reproduce the soundfield.

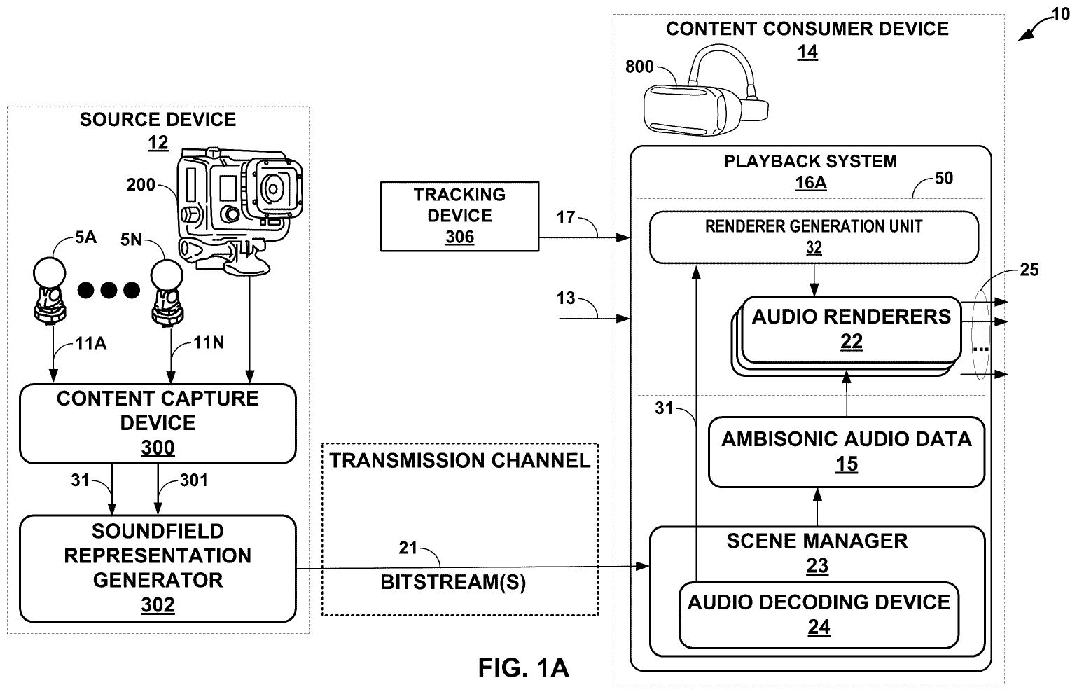

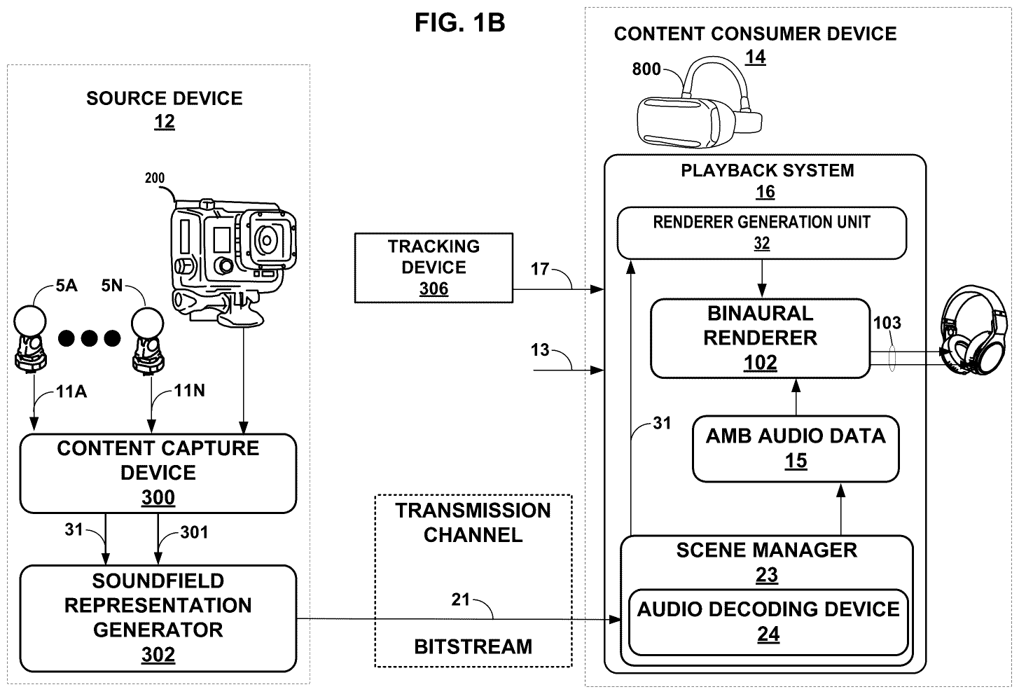

The use of ambisonic coefficients for XR may enable development of a number of use cases that rely on the more immersive soundfields provided by the ambisonic coefficients, particularly for computer gaming applications and live visual streaming applications. In these highly dynamic use cases that rely on low latency reproduction of the soundfield, the XR devices may prefer ambisonic coefficients over other representations that are more difficult to manipulate or involve complex rendering. More information regarding these use cases is provided below with respect to FIGS. 1A and 1B.

While described in this disclosure with respect to the VR device, various aspects of the techniques may be performed in the context of other devices, such as a mobile device. In this instance, the mobile device (such as a so-called smartphone) may present the displayed world via a screen, which may be mounted to the head of the user 102 or viewed as would be done when normally using the mobile device. As such, any information on the screen can be part of the mobile device. The mobile device may be able to provide tracking information and thereby allow for both a VR experience (when head mounted) and a normal experience to view the displayed world, where the normal experience may still allow the user to view the displayed world proving a VR-lite-type experience (e.g., holding up the device and rotating or translating the device to view different portions of the displayed world).

FIGS. 1A and 1B are diagrams illustrating systems that may perform various aspects of the techniques described in this disclosure. As shown in the example of FIG. 1A, system 10 includes a source device 12 and a content consumer device 14. While described in the context of the source device 12 and the content consumer device 14, the techniques may be implemented in any context in which any hierarchical representation of a soundfield is encoded to form a bitstream representative of the audio data. Moreover, the source device 12 may represent any form of computing device capable of generating hierarchical representation of a soundfield, and is generally described herein in the context of being a VR content creator device. Likewise, the content consumer device 14 may represent any form of computing device capable of implementing the audio stream interpolation techniques described in this disclosure as well as audio playback, and is generally described herein in the context of being a VR client device.

The source device 12 may be operated by an entertainment company or other entity that may generate multi-channel audio content for consumption by operators of content consumer devices, such as the content consumer device 14. In many VR scenarios, the source device 12 generates audio content in conjunction with visual content. The source device 12 includes a content capture device 300 and a content soundfield representation generator 302.

The content capture device 300 may be configured to interface or otherwise communicate with one or more microphones 5A-5N (“microphones 5”). The microphones 5 may represent an Eigenmike® or other type of 3D audio microphone capable of capturing and representing the soundfield as corresponding scene-based audio data 11A-11N (which may also be referred to as ambisonic coefficients 11A-11N or “ambisonic coefficients 11”). In the context of scene-based audio data 11 (which is another way to refer to the ambisonic coefficients 11″), each of the microphones 5 may represent a cluster of microphones arranged within a single housing according to set geometries that facilitate generation of the ambisonic coefficients 11. As such, the term microphone may refer to a cluster of microphones (which are actually geometrically arranged transducers) or a single microphone (which may be referred to as a spot microphone or spot transducer).

The ambisonic coefficients 11 may represent one example of an audio stream. As such, the ambisonic coefficients 11 may also be referred to as audio streams 11. Although described primarily with respect to the ambisonic coefficients 11, the techniques may be performed with respect to other types of audio streams, including pulse code modulated (PCM) audio streams, channel-based audio streams, object-based audio streams, etc.

The content capture device 300 may, in some examples, include an integrated microphone that is integrated into the housing of the content capture device 300. The content capture device 300 may interface wirelessly or via a wired connection with the microphones 5. Rather than capture, or in conjunction with capturing, audio data via the microphones 5, the content capture device 300 may process the ambisonic coefficients 11 after the ambisonic coefficients 11 are input via some type of removable storage, wirelessly, and/or via wired input processes, or alternatively or in conjunction with the foregoing, generated or otherwise created (from stored sound samples, such as is common in gaming applications, etc.). As such, various combinations of the content capture device 300 and the microphones 5 are possible.

The content capture device 300 may also be configured to interface or otherwise communicate with the soundfield representation generator 302. The soundfield representation generator 302 may include any type of hardware device capable of interfacing with the content capture device 300. The soundfield representation generator 302 may use the ambisonic coefficients 11 provided by the content capture device 300 to generate various representations of the same soundfield represented by the ambisonic coefficients 11.

For instance, to generate the different representations of the soundfield using ambisonic coefficients (which again is one example of the audio streams), the soundfield representation generator 24 may use a coding scheme for ambisonic representations of a soundfield, referred to as Mixed Order Ambisonics (MOA) as discussed in more detail in U.S. application Ser. No. 15/672,058, entitled “MIXED-ORDER AMBISONICS (MOA) AUDIO DATA FO COMPUTER-MEDIATED REALITY SYSTEMS,” filed Aug. 8, 2017, and published as U.S. patent publication no. 20190007781 on Jan. 3, 2019.

To generate a particular MOA representation of the soundfield, the soundfield representation generator 24 may generate a partial subset of the full set of ambisonic coefficients (where the term “subset” is used not in the strict mathematical sense to include zero or more, if not all, of the full set, but instead may refer to one or more, but not all of the full set). For instance, each MOA representation generated by the soundfield representation generator 24 may provide precision with respect to some areas of the soundfield, but less precision in other areas. In one example, an MOA representation of the soundfield may include eight (8) uncompressed ambisonic coefficients, while the third order ambisonic representation of the same soundfield may include sixteen (16) uncompressed ambisonic coefficients. As such, each MOA representation of the soundfield that is generated as a partial subset of the ambisonic coefficients may be less storage-intensive and less bandwidth intensive (if and when transmitted as part of the bitstream 27 over the illustrated transmission channel) than the corresponding third order ambisonic representation of the same soundfield generated from the ambisonic coefficients.

Although described with respect to MOA representations, the techniques of this disclosure may also be performed with respect to first-order ambisonic (FOA) representations in which all of the ambisonic coefficients associated with a first order spherical basis function and a zero order spherical basis function are used to represent the soundfield. In other words, rather than represent the soundfield using a partial, non-zero subset of the ambisonic coefficients, the soundfield representation generator 302 may represent the soundfield using all of the ambisonic coefficients for a given order N, resulting in a total of ambisonic coefficients equaling (N+1)².

In this respect, the ambisonic audio data (which is another way to refer to the ambisonic coefficients in either MOA representations or full order representations, such as the first-order representation noted above) may include ambisonic coefficients associated with spherical basis functions having an order of one or less (which may be referred to as “1st order ambisonic audio data”), ambisonic coefficients associated with spherical basis functions having a mixed order and suborder (which may be referred to as the “MOA representation” discussed above), or ambisonic coefficients associated with spherical basis functions having an order greater than one (which is referred to above as the “full order representation”).

The content capture device 300 may, in some examples, be configured to wirelessly communicate with the soundfield representation generator 302. In some examples, the content capture device 300 may communicate, via one or both of a wireless connection or a wired connection, with the soundfield representation generator 302. Via the connection between the content capture device 300 and the soundfield representation generator 302, the content capture device 300 may provide content in various forms of content, which, for purposes of discussion, are described herein as being portions of the ambisonic coefficients 11.

In some examples, the content capture device 300 may leverage various aspects of the soundfield representation generator 302 (in terms of hardware or software capabilities of the soundfield representation generator 302). For example, the soundfield representation generator 302 may include dedicated hardware configured to (or specialized software that when executed causes one or more processors to) perform psychoacoustic audio encoding (such as a unified speech and audio coder denoted as “USAC” set forth by the Moving Picture Experts Group (MPEG), the MPEG-H 3D audio coding standard, the MPEG-I Immersive Audio standard, or proprietary standards, such as AptX™ (including various versions of AptX such as enhanced AptX—E-AptX, AptX live, AptX stereo, and AptX high definition—AptX-HD), advanced audio coding (AAC), Audio Codec 3 (AC-3), Apple Lossless Audio Codec (ALAC), MPEG-4 Audio Lossless Streaming (ALS), enhanced AC-3, Free Lossless Audio Codec (FLAC), Monkey's Audio, MPEG-1 Audio Layer II (MP2), MPEG-1 Audio Layer III (MP3), Opus, and Windows Media Audio (WMA).

The content capture device 300 may not include the psychoacoustic audio encoder dedicated hardware or specialized software and instead provide audio aspects of the content 301 in a non-psychoacoustic audio coded form. The soundfield representation generator 302 may assist in the capture of content 301 by, at least in part, performing psychoacoustic audio encoding with respect to the audio aspects of the content 301.

The soundfield representation generator 302 may also assist in content capture and transmission by generating one or more bitstreams 21 based, at least in part, on the audio content (e.g., MOA representations, third order ambisonic representations, and/or first order ambisonic representations) generated from the ambisonic coefficients 11. The bitstream 21 may represent a compressed version of the ambisonic coefficients 11 (and/or the partial subsets thereof used to form MOA representations of the soundfield) and any other different types of the content 301 (such as a compressed version of spherical visual data, image data, or text data).

The soundfield representation generator 302 may generate the bitstream 21 for transmission, as one example, across a transmission channel, which may be a wired or wireless channel, a data storage device, or the like. The bitstream 21 may represent an encoded version of the ambisonic coefficients 11 (and/or the partial subsets thereof used to form MOA representations of the soundfield) and may include a primary bitstream and another side bitstream, which may be referred to as side channel information. In some instances, the bitstream 21 representing the compressed version of the ambisonic coefficients 11 may conform to bitstreams produced in accordance with the MPEG-H 3D audio coding standard and/or an MPEG-I standard for “Coded Representations of Immersive Media.”

The content consumer device 14 may be operated by an individual, and may represent a VR client device. Although described with respect to a VR client device, content consumer device 14 may represent other types of devices, such as an augmented reality (AR) client device, a mixed reality (MR) client device (or any other type of head-mounted display device or extended reality—XR—device), a standard computer, a headset, headphones, or any other device capable of tracking head movements and/or general translational movements of the individual operating the client consumer device 14. As shown in the example of FIG. 1A, the content consumer device 14 includes an audio playback system 16A, which may refer to any form of audio playback system capable of rendering ambisonic coefficients (whether in form of first order, second order, and/or third order ambisonic representations and/or MOA representations) for playback as multi-channel audio content.

The content consumer device 14 may retrieve the bitstream 21 directly from the source device 12. In some examples, the content consumer device 12 may interface with a network, including a fifth generation (5G) cellular network, to retrieve the bitstream 21 or otherwise cause the source device 12 to transmit the bitstream 21 to the content consumer device 14.

While shown in FIG. 1A as being directly transmitted to the content consumer device 14, the source device 12 may output the bitstream 21 to an intermediate device positioned between the source device 12 and the content consumer device 14. The intermediate device may store the bitstream 21 for later delivery to the content consumer device 14, which may request the bitstream. The intermediate device may comprise a file server, a web server, a desktop computer, a laptop computer, a tablet computer, a mobile phone, a smart phone, or any other device capable of storing the bitstream 21 for later retrieval by an audio decoder. The intermediate device may reside in a content delivery network capable of streaming the bitstream 21 (and possibly in conjunction with transmitting a corresponding visual data bitstream) to subscribers, such as the content consumer device 14, requesting the bitstream 21.

Alternatively, the source device 12 may store the bitstream 21 to a storage medium, such as a compact disc, a digital visual disc, a high definition visual disc or other storage media, most of which are capable of being read by a computer and therefore may be referred to as computer-readable storage media or non-transitory computer-readable storage media. In this context, the transmission channel may refer to the channels by which content stored to the mediums are transmitted (and may include retail stores and other store-based delivery mechanism). In any event, the techniques of this disclosure should not therefore be limited in this respect to the example of FIG. 1A.

As noted above, the content consumer device 14 includes the audio playback system 16. The audio playback system 16 may represent any system capable of playing back multi-channel audio data. The audio playback system 16A may include a number of different audio renderers 22. The renderers 22 may each provide for a different form of audio rendering, where the different forms of rendering may include one or more of the various ways of performing vector-base amplitude panning (VBAP), and/or one or more of the various ways of performing soundfield synthesis. As used herein, “A and/or B” means “A or B”, or both “A and B”.

The audio playback system 16A may further include an audio decoding device 24. The audio decoding device 24 may represent a device configured to decode bitstream 21 to output reconstructed ambisonic coefficients 11A′-11N′ (which may form the full first, second, and/or third order ambisonic representation or a subset thereof that forms an MOA representation of the same soundfield or decompositions thereof, such as the predominant audio signal, ambient ambisonic coefficients, and the vector based signal described in the MPEG-H 3D Audio Coding Standard and/or the MPEG-I Immersive Audio standard).

As such, the ambisonic coefficients 11A′-11N′ (“ambisonic coefficients 11′”) may be similar to a full set or a partial subset of the ambisonic coefficients 11, but may differ due to lossy operations (e.g., quantization) and/or transmission via the transmission channel. The audio playback system 16 may, after decoding the bitstream 21 to obtain the ambisonic coefficients 11′, obtain ambisonic audio data 15 from the different streams of ambisonic coefficients 11′, and render the ambisonic audio data 15 to output speaker feeds 25. The speaker feeds 25 may drive one or more speakers (which are not shown in the example of FIG. 1A for ease of illustration purposes). Ambisonic representations of a soundfield may be normalized in a number of ways, including N3D, SN3D, FuMa, N2D, or SN2D.

To select the appropriate renderer or, in some instances, generate an appropriate renderer, the audio playback system 16A may obtain loudspeaker information 13 indicative of a number of loudspeakers and/or a spatial geometry of the loudspeakers. In some instances, the audio playback system 16A may obtain the loudspeaker information 13 using a reference microphone and outputting a signal to activate (or, in other words, drive) the loudspeakers in such a manner as to dynamically determine, via the reference microphone, the loudspeaker information 13. In other instances, or in conjunction with the dynamic determination of the loudspeaker information 13, the audio playback system 16A may prompt a user to interface with the audio playback system 16A and input the loudspeaker information 13.

The audio playback system 16A may select one of the audio renderers 22 based on the loudspeaker information 13. In some instances, the audio playback system 16A may, when none of the audio renderers 22 are within some threshold similarity measure (in terms of the loudspeaker geometry) to the loudspeaker geometry specified in the loudspeaker information 13, generate the one of audio renderers 22 based on the loudspeaker information 13. The audio playback system 16A may, in some instances, generate one of the audio renderers 22 based on the loudspeaker information 13 without first attempting to select an existing one of the audio renderers 22.

When outputting the speaker feeds 25 to headphones, the audio playback system 16A may utilize one of the renderers 22 that provides for binaural rendering using head-related transfer functions (HRTF) or other functions capable of rendering to left and right speaker feeds 25 for headphone speaker playback. The terms “speakers” or “transducer” may generally refer to any speaker, including loudspeakers, headphone speakers, etc. One or more speakers may then playback the rendered speaker feeds 25.

Although described as rendering the speaker feeds 25 from the ambisonic audio data 15, reference to rendering of the speaker feeds 25 may refer to other types of rendering, such as rendering incorporated directly into the decoding of the ambisonic audio data 15 from the bitstream 21. An example of the alternative rendering can be found in Annex G of the MPEG-H 3D audio coding standard, where rendering occurs during the predominant signal formulation and the background signal formation prior to composition of the soundfield. As such, reference to rendering of the ambisonic audio data 15 should be understood to refer to both rendering of the actual ambisonic audio data 15 or decompositions or representations thereof of the ambisonic audio data 15 (such as the above noted predominant audio signal, the ambient ambisonic coefficients, and/or the vector-based signal — which may also be referred to as a V-vector).

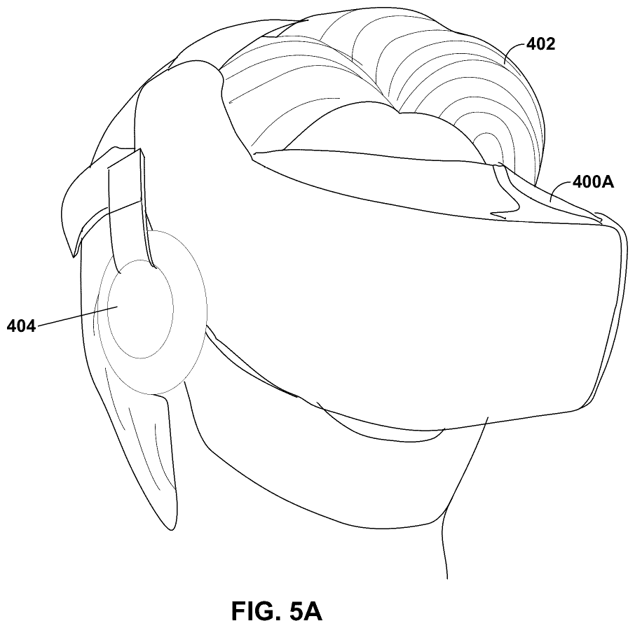

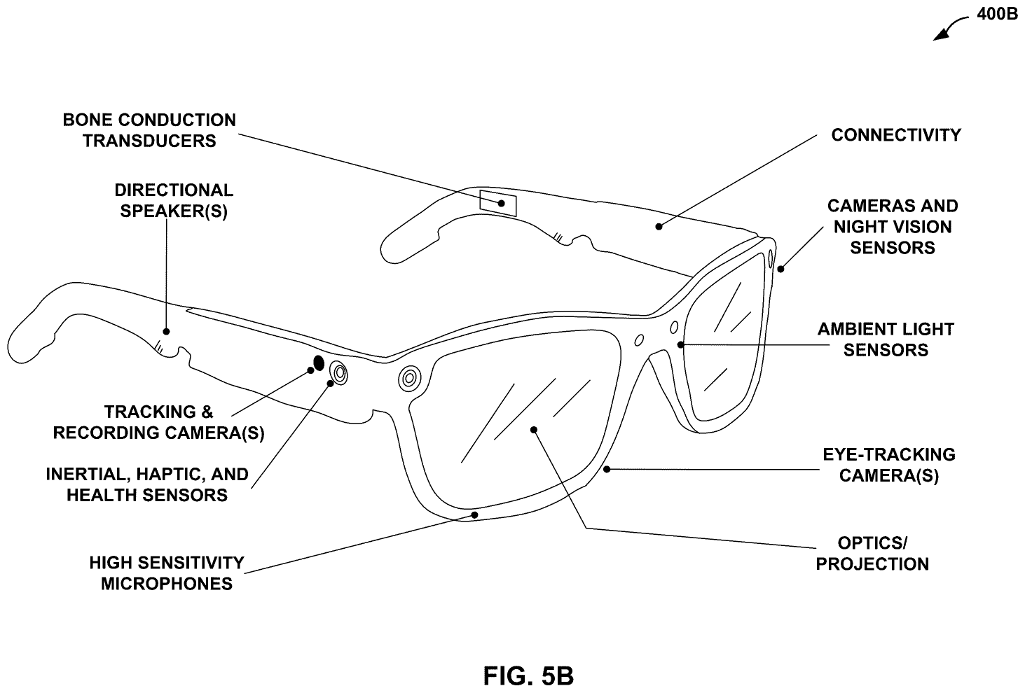

As described above, the content consumer device 14 may represent a VR device in which a human wearable display is mounted in front of the eyes of the user operating the VR device. FIGS. 5A and 5B are diagrams illustrating examples of VR devices 400A and 400B. In the example of FIG. 5A, the VR device 400A is coupled to, or otherwise includes, headphones 404, which may reproduce a soundfield represented by the ambisonic audio data 15 (which is another way to refer to ambisonic coefficients 15) through playback of the speaker feeds 25. The speaker feeds 25 may represent an analog or digital signal capable of causing a membrane within the transducers of headphones 404 to vibrate at various frequencies. Such a process is commonly referred to as driving the headphones 404.

Visual, audio, and other sensory data may play important roles in the VR experience. To participate in a VR experience, a user 402 may wear the VR device 400A (which may also be referred to as a VR headset 400A) or other wearable electronic device. The VR client device (such as the VR headset 400A) may track head movement of the user 402, and adapt the visual data shown via the VR headset 400A to account for the head movements, providing an immersive experience in which the user 402 may experience a virtual world shown in the visual data in visual three dimensions.

While VR (and other forms of AR and/or MR, which may generally be referred to as a computer mediated reality device) may allow the user 402 to reside in the virtual world visually, often the VR headset 400A may lack the capability to place the user in the virtual world audibly. In other words, the VR system (which may include a computer responsible for rendering the visual data and audio data—that is not shown in the example of FIG. 5A for ease of illustration purposes, and the VR headset 400A) may be unable to support full three dimension immersion audibly.

FIG. 5B is a diagram illustrating an example of a wearable device 400B that may operate in accordance with various aspect of the techniques described in this disclosure. In various examples, the wearable device 400B may represent a VR headset (such as the VR headset 400A described above), an AR headset, an MR headset, or any other type of XR headset. Augmented Reality “AR” may refer to computer rendered image or data that is overlaid over the real world where the user is actually located. Mixed Reality “MR” may refer to computer rendered image or data that is world locked to a particular location in the real world, or may refer to a variant on VR in which part computer rendered 3D elements and part photographed real elements are combined into an immersive experience that simulates the user's physical presence in the environment. Extended Reality “XR” may represent a catchall term for VR, AR, and MR. More information regarding terminology for XR can be found in a document by Jason Peterson, entitled “Virtual Reality, Augmented Reality, and Mixed Reality Definitions,” and dated Jul. 7, 2017.

The wearable device 400B may represent other types of devices, such as a watch (including so-called “smart watches”), glasses (including so-called “smart glasses”), headphones (including so-called “wireless headphones” and “smart headphones”), smart clothing, smart jewelry, and the like. Whether representative of a VR device, a watch, glasses, and/or headphones, the wearable device 400B may communicate with the computing device supporting the wearable device 400B via a wired connection or a wireless connection.

In some instances, the computing device supporting the wearable device 400B may be integrated within the wearable device 400B and as such, the wearable device 400B may be considered as the same device as the computing device supporting the wearable device 400B. In other instances, the wearable device 400B may communicate with a separate computing device that may support the wearable device 400B. In this respect, the term “supporting” should not be understood to require a separate dedicated device but that one or more processors configured to perform various aspects of the techniques described in this disclosure may be integrated within the wearable device 400B or integrated within a computing device separate from the wearable device 400B.

For example, when the wearable device 400B represents an example of the VR device 400B, a separate dedicated computing device (such as a personal computer including the one or more processors) may render the audio and visual content, while the wearable device 400B may determine the translational head movement upon which the dedicated computing device may render, based on the translational head movement, the audio content (as the speaker feeds) in accordance with various aspects of the techniques described in this disclosure. As another example, when the wearable device 400B represents smart glasses, the wearable device 400B may include the one or more processors that both determine the translational head movement (by interfacing within one or more sensors of the wearable device 400B) and render, based on the determined translational head movement, the speaker feeds.

As shown, the wearable device 400B includes one or more directional speakers, and one or more tracking and/or recording cameras. In addition, the wearable device 400B includes one or more inertial, haptic, and/or health sensors, one or more eye-tracking cameras, one or more high sensitivity audio microphones, and optics/projection hardware. The optics/projection hardware of the wearable device 400B may include durable semi-transparent display technology and hardware.

The wearable device 400B also includes connectivity hardware, which may represent one or more network interfaces that support multimode connectivity, such as 4G communications, 5G communications, Bluetooth, etc. The wearable device 400B also includes one or more ambient light sensors, and bone conduction transducers. In some instances, the wearable device 400B may also include one or more passive and/or active cameras with fisheye lenses and/or telephoto lenses. Although not shown in FIG. 5B, the wearable device 400B also may include one or more light emitting diode (LED) lights. In some examples, the LED light(s) may be referred to as “ultra bright” LED light(s). The wearable device 400B also may include one or more rear cameras in some implementations. It will be appreciated that the wearable device 400B may exhibit a variety of different form factors.

Furthermore, the tracking and recording cameras and other sensors may facilitate the determination of translational distance. Although not shown in the example of FIG. 5B, wearable device 400B may include other types of sensors for detecting translational distance.

Although described with respect to particular examples of wearable devices, such as the VR device 400B discussed above with respect to the examples of FIG. 5B and other devices set forth in the examples of FIGS. 1A and 1B, a person of ordinary skill in the art would appreciate that descriptions related to FIGS. 1A-5B may apply to other examples of wearable devices. For example, other wearable devices, such as smart glasses, may include sensors by which to obtain translational head movements. As another example, other wearable devices, such as a smart watch, may include sensors by which to obtain translational movements. As such, the techniques described in this disclosure should not be limited to a particular type of wearable device, but any wearable device may be configured to perform the techniques described in this disclosure.

In the example of FIG. 1A, the source device 12 further includes a camera 200. The camera 200 may be configured to capture visual data, and provide the captured raw visual data to the content capture device 300. The content capture device 300 may provide the visual data to another component of the source device 12, for further processing into viewport-divided portions.

The content consumer device 14 also includes the wearable device 800. It will be understood that, in various implementations, the wearable device 800 may be included in, or externally coupled to, the content consumer device 14. As discussed above with respect to FIGS. 5A and 5B, the wearable device 800 includes display hardware and speaker hardware for outputting visual data (e.g., as associated with various viewports) and for rendering audio data.

In any event, the audio aspects of VR have been classified into three separate categories of immersion. The first category provides the lowest level of immersion, and is referred to as three degrees of freedom (3DOF). 3DOF refers to audio rendering that accounts for movement of the head in the three degrees of freedom (yaw, pitch, and roll), thereby allowing the user to freely look around in any direction. 3DOF, however, cannot account for translational head movements in which the head is not centered on the optical and acoustical center of the soundfield.

The second category, referred to 3DOF plus (3DOF+), provides for the three degrees of freedom (yaw, pitch, and roll) in addition to limited spatial translational movements due to the head movements away from the optical center and acoustical center within the soundfield. 3DOF+ may provide support for perceptual effects such as motion parallax, which may strengthen the sense of immersion.

The third category, referred to as six degrees of freedom (6DOF), renders audio data in a manner that accounts for the three degrees of freedom in term of head movements (yaw, pitch, and roll) but also accounts for translation of the user in space (x, y, and z translations). The spatial translations may be induced by sensors tracking the location of the user in the physical world or by way of an input controller.

3DOF rendering is the current state of the art for audio aspects of VR. As such, the audio aspects of VR are less immersive than the visual aspects, thereby potentially reducing the overall immersion experienced by the user, and introducing localization errors (e.g., such as when the auditory playback does not match or correlate exactly to the visual scene).

Although 3DOF rendering is the current state, more immersive audio rendering, such as 3DOF+ and 6DOF rendering, may result in higher complexity in terms of processor cycles expended, memory and bandwidth consumed, etc. Furthermore, rendering for 6DOF may require additional granularity in terms of pose (which may refer to position and/or orientation) that results in the higher complexity, while also complicating certain XR scenarios in terms of asynchronous capture of audio data and visual data.

For example, consider XR scenes that involve live audio data capture (e.g., XR conferences, visual conferences, visual chat, metaverses, XR games, etc.) in which avatars (an example visual object) speak to one another using microphones to capture the live audio and convert such live audio into audio objects (which may also be referred to as audio elements as the audio objects are not necessarily defined in the object format). 3DOF rendering may attempt to locate the audio elements into a general area of the corresponding avatar, providing loose colocation of audio elements to visual objects (which may also be referred to as visual elements). The lack of tighter colocation of audio elements relative to visual elements may reduce immersion and potentially result in difficulty interpreting the visual scene.

Furthermore, a number of reference playback systems (which may be referred to as reference architectures) proposed via various standards, such as advanced coding (AC) fourth generation (AC-4), MPEG-H 3D audio coding standard, MPEG-I immersive coding standard, third generation partnership project (3GPP) standards, etc., may combine audio decoding with audio rendering in a so-called monolithic audio system. However, in some instances, external renderers (which may refer to renderers not configured to operate in the context of audio decoding) may be useful, e.g., when rendering to a special class of devices that are not covered by built-in rendering (meaning rendering built-in to the audio decoding system). In these instances, the signal in the bitstream should normally be decoded and presented to this external renderer to avoid quality constraints compared to a rendering in the audio decoder to an intermediate format that is then re-rendered by the external renderer. In these instances, there are two instantiations using a decoder built-in rendering and an external rendering.

In accordance with various aspects of the techniques described in this disclosure, the playback system 16 may include a separate audio unit 50 that provides a separate audio interface to facilitate rendering at the playback system 16. The techniques may enable the playback system 16 to synchronize playback of audio elements to playback of visual elements (which may refer to AR/VR/XR video elements, video data element, and/or any element meant to be viewed). The audio unit 50 may include an interface (such as an application programming interface—API) that the audio unit 50 may expose in order to facilitate interactions with a scene manager 23 that manages playback of one or more visual elements that support an extended reality (XR) scene.

The scene manager 23 may represent a unified interface for renderer components to access audio streams associated with an audio element in a so-called scene state. The scene state may reflect a current state of all scene elements (e.g., video elements and/or audio elements), transforms/anchors, and geometry. Other components of the renderer may subscribe to changes in the scene state. Before rendering begins, all elements in the entire scene are created and the associated metadata is updated to the state that reflects an intended scene configuration at a start of playback. Audio streams are input to the renderer as PCM float samples. The source of an audio stream may for example be decoded MPEG-H audio streams or locally captured audio.

In some instances, the audio elements may not be captured at the same time as the visual elements or may be added later (e.g., during a XR mediated conference, such as an XR videoconference). As such, the playback system 16 may invoke the scene manager 23 to match one or more visual elements to one or more audio elements (e.g., by comparing a name or other unique identifier—UID—associated with each of the one or more visual elements and one or more audio elements). The scene manager 23 may modify audio metadata defining a pose (which may refer to a position and/or orientation) of the one or more audio elements to more closely correspond to the matching one or more visual elements. The scene manager 23 may then output the modified audio metadata to an audio unit 50 of the audio playback system, which may render the audio elements to one or more speaker feeds 25. The playback system 16 may then output the one or more speaker feeds 25 to one or more speakers (which may also be referred to as loudspeakers, headphone speakers, or more generally as transducers).

In operation, the scene manager 23 may map, based on visual metadata associated with the at least one visual element and audio metadata associated with the at least one audio element (both of which may be obtained by parsing the bitstreams 21 during decoding—e.g., by audio decoding device 24 for audio data specified via the bitstreams 21), the at least one visual element to the at least one audio element. Scene manager 23 may identify a unique identifier (UID) and/or name in the visual metadata and audio metadata, comparing the UID and/or name (UID/name) associated with each visual element and each audio element to map one or more of the visual elements to one or more of the audio elements.

The scene manager 23 may next modify, based on the mapping of the at least one visual element to the at least one audio element, the audio metadata to obtain modified audio metadata. The audio unit 50 may present the API that the scene manager 23 may invoke to provide the modified audio metadata to the audio unit 50 via an API call.

The audio unit 50 may render, based on the modified audio metadata, the at least one audio element to the one or more speaker feeds 25, outputting the one or more speaker feeds 25 to one or more transducers (e.g., headphones, loudspeakers, etc.). That is, the audio unit 50 may configure one or more of the audio renderers 22 to based on pose information specified by the modified audio metadata. The pose information (which may be denoted as a “pose” associated with the visual element and/or audio element) may define a location and an orientation (where both a location and an orientation is representative of 6DOF location information) of the corresponding element.

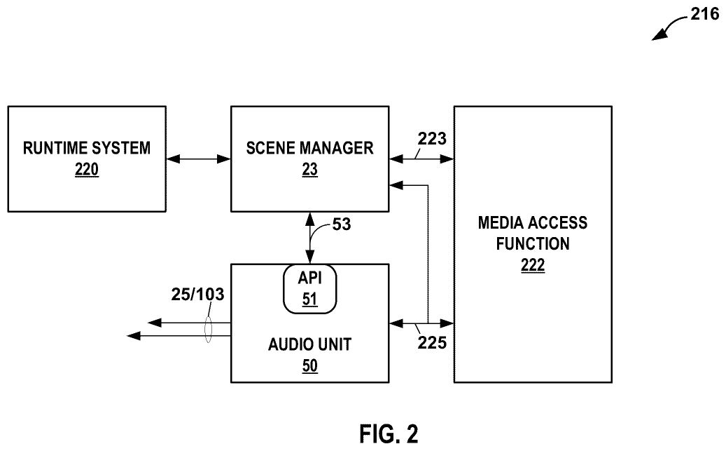

Given that the audio element may be captured asynchronously from the visual element (which may be computer generated and not necessarily captured but otherwise generated asynchronously), the pose of the audio element may not tightly correspond to the pose of the video element. As such, the scene manager 23 may modify the pose of the audio element in the audio metadata to more accurately reflect the pose of the visual element in the XR scene. As described below with respect to FIGS. 2-4, the API of the audio unit 50 may facilitate updating the pose of the audio element in near-real-time to reduce latency and thereby improve immersion of the XR scene (especially when consumed via a wearable such as the XR device 800).

As such, the techniques may improve operation of the playback system 16 as the playback system 16 may more accurately reproduce a soundfield (based on the one or more speaker feeds) to potentially improve the immersive experience of XR systems, such as system 10. That is, rather than render the audio elements based on low resolution audio metadata that may not match the corresponding visual element, the playback system 16 may modify the audio metadata to more closely match the corresponding visual element, thereby increasing the immersion of the XR experience through higher resolution audio metadata. As such, various aspects of the techniques described in this disclosure may improve the playback system 16 itself.

FIG. 1B is a block diagram illustrating another example system 100 configured to perform various aspects of the techniques described in this disclosure. The system 100 is similar to the system 10 shown in FIG. 1A, except that the audio renderers 22 shown in FIG. 1A are replaced with a binaural renderer 102 capable of performing binaural rendering using one or more HRTFs or the other functions capable of rendering to left and right speaker feeds 103.

The audio playback system 16B may output the left and right speaker feeds 103 to headphones 104, which may represent another example of a wearable device and which may be coupled to additional wearable devices to facilitate reproduction of the soundfield, such as a watch, the VR headset noted above, smart glasses, smart clothing, smart rings, smart bracelets or any other types of smart jewelry (including smart necklaces), and the like. The headphones 104 may couple wirelessly or via wired connection to the additional wearable devices.

Additionally, the headphones 104 may couple to the audio playback system 16 via a wired connection (such as a standard 3.5 mm audio jack, a universal system bus (USB) connection, an optical audio jack, or other forms of wired connection) or wirelessly (such as by way of a Bluetooth™ connection, a wireless network connection, and the like). The headphones 104 may recreate, based on the left and right speaker feeds 103, the soundfield represented by the ambisonic coefficients 11. The headphones 104 may include a left headphone speaker and a right headphone speaker which are powered (or, in other words, driven) by the corresponding left and right speaker feeds 103.

Although described with respect to a VR device as shown in the example of FIGS. 5A and 5B, the techniques may be performed by other types of wearable devices, including watches (such as so-called “smart watches”), glasses (such as so-called “smart glasses”), headphones (including wireless headphones coupled via a wireless connection, or smart headphones coupled via wired or wireless connection), and any other type of wearable device. As such, the techniques may be performed by any type of wearable device by which a user may interact with the wearable device while worn by the user.

FIGS. 2-4 are block diagrams illustrating example architectures of the playback system shown in the example of FIGS. 1A and/or 1B for performing various aspects of the audio rendering techniques described in this disclosure. Referring first to the example of FIG. 2, a playback system 216 may represent an example of playback system 16. The playback system 216 includes a runtime system 220, a media access function 222, a scene manager 23, and audio subsystem 50.

Runtime system 220 may represent a unit configured to support processing of sensor data, viewport rendering, as well as, simultaneous localization and mapping (SLAM) processing. Runtime system 220 may operate with respect to a graphic language transmission format (glTF™) that specifies visual elements as 3D scenes (which is one example of XR scenes). Scene manager 23 may processing the glTF™ elements to unpack and use the underlying assets (which is another way to refer to visual elements and/or visual elements). Scene manager 23 may also process audio bitstreams separate from the bitstream formatted according to glTF™.

Media access function (MAF) 222 may represent a unit configured to obtain media content, such as visual bitstreams that specify at least one visual element and audio bitstreams that specify audio elements (or, in other words, audio source elements). MAF 222 may enable access to media data (which is another way to refer to the media content)to be communicated through various delivery networks (such as the Internet via wired, wireless, etc. communication networks including various cellular networks, such as fifth generation—5G—cellular networks). 3GPP TR 26.998 may represent one example standard by which to provide immersive XR media codecs/profiles by which to integrate glass-type XR devices into the 5G network.

In any event, the audio unit 50 may expose an API 51 by which to interface with audio unit 50 to register callbacks 53. The callbacks 53 may represent a function that is passed into another function (e.g., the audio unit 50) as an argument to be executed later (e.g., prior to rendering each frame of the audio bitstream(s)). The scene manager 23 may map, based on visual metadata associated with the at least one visual element 223 and audio metadata associated with the at least one audio element 225, the at least one visual element 223 to the at least one audio element 225.

As noted above, the visual metadata may include a pose of the at least one visual element 223 in the XR scene, and the audio metadata may include a pose of the at least one audio element in the XR scene. The scene manager 23 may then modify, based on the mapping of the at least one visual element to the at least one audio element, the audio metadata to obtain modified audio metadata. That is, the scene manager 23 may modify, based on the pose of the at least one visual element 223, the position of the at least one audio element 225 to obtain to obtain a modified position of the at least one audio element 225 in the XR scene.

In some examples, the modified pose of the at least one audio element differs from the pose of the at least one audio element. The modified pose of the at least one audio element 225 differs from the pose of the at least one audio element 225 in terms of a rotational angle, an elevation angle, and/or a translational distance.

In other words, the audio element 225 may define a primitive and/or audio meshes, which may be a low resolution (or, stated differently, low-detail) version of the corresponding video element 223. To map the audio element 225 to the associated video element 223, scene manager 23 may perform in-band and/or out-of-band mapping. For in band mapping, scene manager 23 may analyze the audio metadata (defined in the audio bitstream) associated with the audio element 225 to identify an association between the audio element 225 and the video element 223 as defined by the node name in the glTF™. For out-of-band mapping, an extension to the glTF node may define an identifier plus an alignment transform to map the visual node (representative of video element 223) to the corresponding audio element 225.

The scene manager 23 may next register a callback 53 with the audio that includes a transformation for modifying the audio metadata to obtain the modified audio metadata. The audio unit 50 may interface with the media access function 222 to obtain the at least one audio element 225, whereupon the audio unit 50 may render, based on the modified audio metadata (as represented by the callback 53), the at least one audio element to one or more speaker feeds 25/103. The audio unit 50 may then output the one or more speaker feeds 25/103.

In some instances, the scene manager 23 may, when mapping the visual elements 223 to the audio elements 225, determine that none of the at least one visual element 223 maps to the audio elements 225 (e.g., the audio element 225 is nondiegetic, meaning that the audio element 225 is not heard by the characters in the XR scene—such as transition or background music heard by viewers but not by the characters in the XR scene). In this instance, the scene manager 23 may set the unmatched audio element 225 to a general world coordinate system (e.g., (0, 0, 0) in an (X, Y, Z) coordinate system). The scene manager 23 may then register a callback 53 via API 51 of the audio unit 50 to maintain the general world position of the corresponding audio element 225.

The audio unit 50 may render each frame of the audio element 225 based on this callback 53 setting the audio metadata for the audio element 225 to the general world coordinate system. The audio unit 50 may render the audio element 225 as background audio to each of the speaker feeds 25/103.

As noted above, the callback 53 may define a translation and effectively represents the modified audio metadata. In some instances, the audio unit 50 may request, responsive to the callback 53 and prior to rendering the at least one audio element 225, the modified audio metadata. In some examples, the audio unit 50 is configured to request, responsive to the callback and prior to rendering each frame of audio data for the at least one audio element 225, the modified audio metadata.

As such, the relatively simple 3DOF model from 3GPP technical specification (TS) 26.118 with a center point and the shared pose information is extended to operate in a reference space that facilitates the above mapping between visual element and audio elements to support 6DOF in XR systems. The pose may no longer just be the head rotation but may also include the position of the user/camera/audio listener in the 6DOF XR space. In addition, in XR the scene itself may be more complex, including interactions, multiple elements, etc. In the case of 6DOF and XR, the audio unit 50 may provide for proper rendering using significantly more information that just the time synchronization information and pose as in 3DOF to properly render an immersive experience.

To overcome the limitations of 3DOF, the following needs to be defined for the audio listener: 1) a type of audio listener, 2) a pose of the audio listener (which may be obtained via the XR device 800 and/or other sensors), and 3) an alignment of the head related transfer function (HRTF) with the underlying avatar representing the listener in the XR scene. For each audio source, the following needs to be defined: 1) a type of audio source, 2) a corresponding visual element, 3) a pose with respect to a global coordinate system, and 4) timing information (which may be used to synchronize the audio element 225 with the corresponding video element 223 and a start/stop time based on a schedule or interactivity).

The pose is defined relative to a reference space defined/selected by scene manager 23. XR anchoring and interactivity apply to all media types, where anchoring may associate a given video/audio element to a set location in the XR world, the real-world, etc. The audio unit 50 may act as a so-called “black box” that exchanges information with the scene manager 23 via one or more APIs 51.

In this context, the audio unit 50 may operate in a 6DOF/XR audio-visual system 10. The 6DOF/XR experience is described by a scene that may include one or more elements that have assigned both audio and visual properties. The 6DOF XR audio-visual experience may include the ability to freely move at least in a restricted place. The XR scene may allow for modification, updates, and interactions with the scene and/or elements in the scene such that the audio or visual properties may change.

Scene manager 23 (which may also be referred to as a presentation engine 23) may utilize hooks that modify or interject spatial audio metadata information, which is then used by the audio unit 50 to decode and render the 6DOF audio in synchronization with the visual experience (provided by way of the visual elements). In this example, the so-called “hook” is realized in the form of callback 53, which may be periodic or on-demand (e.g., as required by the audio unit 50 and/or scene manager 23).

In this way, various aspects of the techniques may enable steering of a 6DOF audio unit. Furthermore, various aspects of the techniques may ensure alignment of the visual scene with the audio scene, driven by a single source while keeping the audio rendering process separate. MPEG-I Audio systems that conform to MPEG-I Audio 23090-4 may perform these techniques.

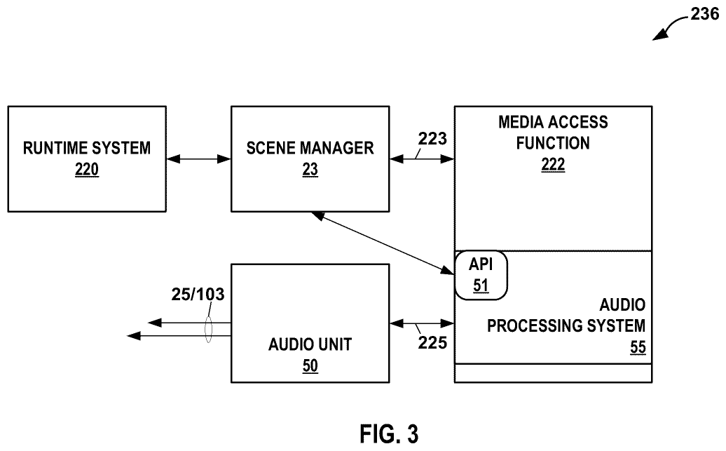

In the example of FIG. 3, a playback system 236 may represent another example of the audio playback system 16. The playback system 236 may be similar to the playback system 216 except that MAF 222 includes an audio processing system 55, which may also be referred to as an audio preprocessing system 55. The audio preprocessing system 55 may expose the API 51 that scene manager 23 may invoke to interface and configure the audio preprocessing system 55 to modify the audio metadata associated with the audio element 225.

Scene manager 23 may configure the audio preprocessing system 55 to modify, based on the mapping of the at least one visual element 223 to the at least one audio element 225, the audio metadata to obtain the modified audio metadata. The audio processing system 55 may insert scene update messages or rewrite existing messages to define the updated audio metadata associated with the audio element 225. In this way, the audio processing system 55 may update a listener pose and/or scene geometry associated with audio scene elements 225 (which is another way to refer to audio elements 225). The audio processing system 55 may replace, based on the configuration (defined via the API 55), the audio metadata in the audio bitstream (defining audio element 225) with the modified audio metadata. The audio processing system 55 may output the audio bitstream (which may be referred to as a modified 6DOF audio bitstream) to the audio unit 50.

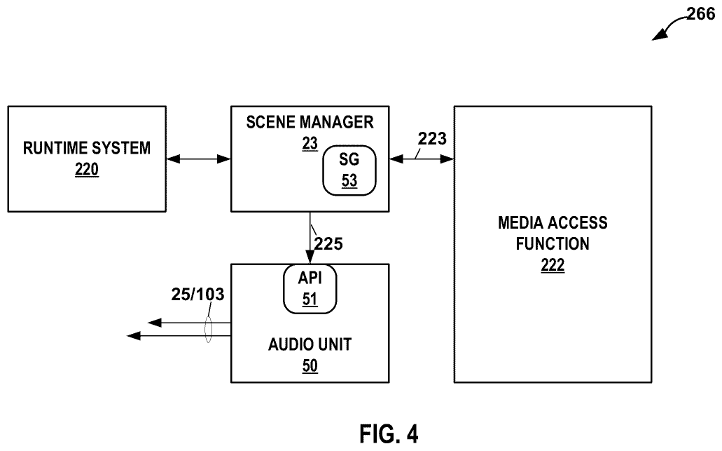

In the example of FIG. 4, a playback system 266 may represent another example of the audio playback system 16. The playback system 266 may be similar to the playback system 216 and/or 236 except that the scene manager 23 may construct, based on the mapping of the at least one visual element 223 to the at least one audio element 225, a scene graph that includes a parent node representative of the at least one visual element 225, and a child node that depends from the parent node and that represents the at least one audio element 223. The scene graph may be similar to the scene graphs that are defined via various gaming platforms, such as the Unity development platform. Scene manager 23 may modify, based on the scene graph, the audio metadata to obtain the modified audio metadata.

In this example, the scene manager 23 is further configured to output the modified audio metadata to the audio unit 50. In some examples, the scene manager 23 is further configured to output, via API 51, exposed by the audio unit 50, the modified audio metadata to the audio unit 50.

By managing synchronization within the scene manager 23, the scene manager 23 may reduce latency associated with configuring the audio processing system 55 and/or configuring the callbacks 53. The scene manager 23 may maintain a single scene and update the single scene instead of relying on separate sets of nodes for visual and audio elements. The scene manager 23 may invoke the API 51 in order to provide the 6DOF audio metadata to the audio unit 50.

In this example, the scene manager 23 may provide inheritance of scene information (e.g., the gITF™ visual element graph) from the visual element 223 to the audio elements 225 that depend from the visual element 223 in the scene graph. An example scene description may be as follows:

```
“nodes”: [
{
  “mesh”: 14,
  “name”: “Propeller”,
  “translation”: [
    0,
    0,
    1.62 ]
},
```

For the MPEG-I Audio Bitstream, the following metadata may be defined:

```
<ObjectSource
  id=”src:propelleraudio”
  position=”0 0 1.62”
  extent=”mesh:Door1”
  signal=”signal:DoorOpen”
  mode=”event”
  gainDb=”−15”
/>
```

The inherited audio metadata for the audio element 225 may be defined as follows:

```
“nodes”: [
{
  “mesh”: 14,
  “name”: “Propeller”,
  “translation”: [
    0,
    0,
    1.62 ]
},
{
  “children”:
    <Insert Audio Object Metadata>
}
```

The above aspects of the techniques may enable the following use cases. First, interactivity, where runtime system 220 captures user actions that modify an audio-visual element position. In the example of FIG. 2, the playback system 216 may require updating visual node in the scene manager 23 and an audio node separately by a callback 53 to the audio unit 50. In the example of FIG. 3, the audio pre-processing system 55 may insert the updated position into the 6DoF audio bitstream. In the example of FIG. 4, the scene manager 23 interfaces with the audio unit 50 with the modified audio metadata used for rendering.

In instances, where audio elements are not mapped to visual representations (nondiegetic audio), the audio playback system 216 may not require a callback 53 to render nondiegetic audio. The playback system 236 may bypass pre-processing of nondiegetic audio elements. The playback system 266 may either passthrough or add as children to the world node {position=0,0,0} the nondiegetic audio elements.

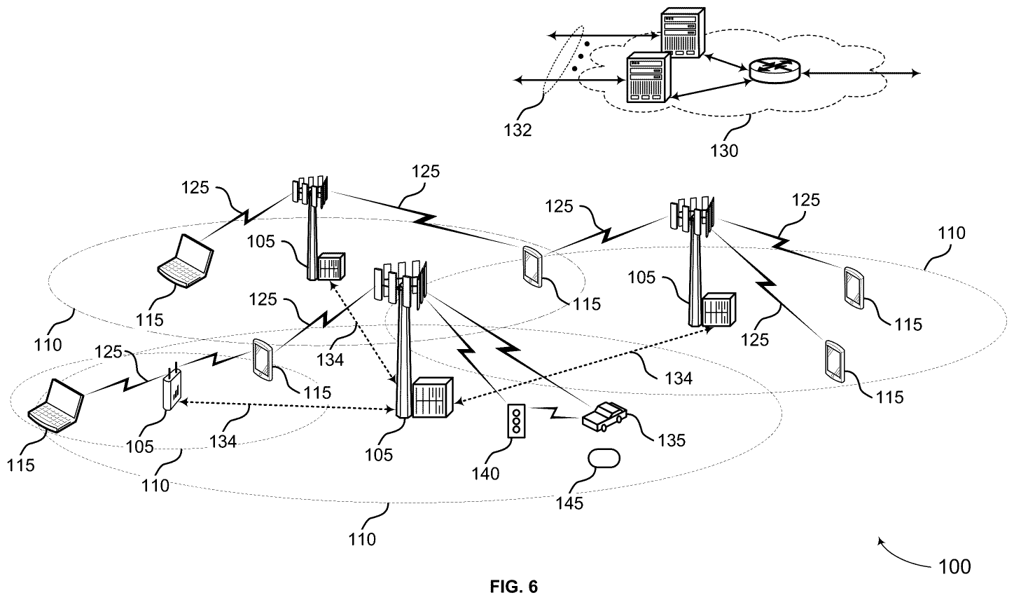

FIG. 6 illustrates an example of a wireless communications system 100 that supports audio streaming in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The Ues 115 described herein may be able to communicate with various types of base stations 105 and network equipment including macro eNBs, small cell eNBs, gNB s, relay base stations, and the like.

Each base station 105 may be associated with a particular geographic coverage area 110 in which communications with various Ues 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

Ues 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In examples of this disclosure, a UE 115 may be any of the audio sources described in this disclosure, including a VR headset, an XR headset, an AR headset, a vehicle, a smartphone, a microphone, an array of microphones, or any other device including a microphone or is able to transmit a captured and/or synthesized audio stream. In some examples, an synthesized audio stream may be an audio stream that that was stored in memory or was previously created or synthesized. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some Ues 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that exchange and/or use audio metadata indicating privacy restrictions and/or password-based privacy data to toggle, mask, and/or null various audio streams and/or audio sources as will be described in more detail below.

In some cases, a UE 115 may also be able to communicate directly with other Ues 115 (e.g., using a peer-to-peer (P2P) or device-to-device (D2D) protocol). One or more of a group of Ues 115 utilizing D2D communications may be within the geographic coverage area 110 of a base station 105. Other Ues 115 in such a group may be outside the geographic coverage area 110 of a base station 105, or be otherwise unable to receive transmissions from a base station 105. In some cases, groups of Ues 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between Ues 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and Ues 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

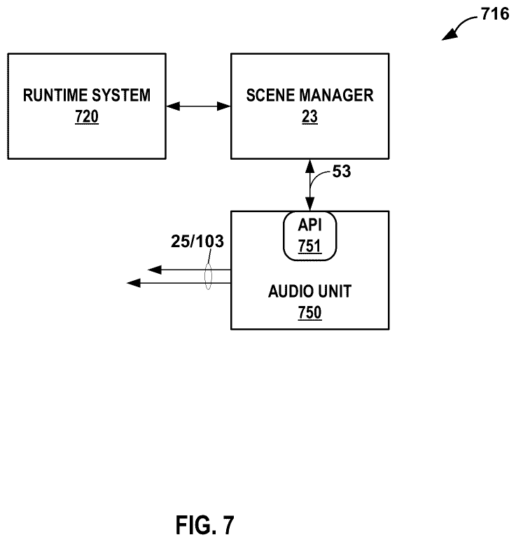

FIGS. 7 is a block diagram illustrating example architectures of the playback system shown in the example of FIGS. 1A and/or 1B for performing various aspects of the audio rendering techniques described in this disclosure. In the example of FIG. 7, a playback system 716 may represent another example of the playback system 216 shown in the example of FIG. 2. The playback system 716 may include a runtime system 720 (which is an example of the runtime system 220) that conforms to the openXRTM specification (or, in other words, the openXRTM standard). The playback system 716 may also include an audio unit 750 (which represents an example of the audio unit 250) that may conform to the MPEG-I audio standard.

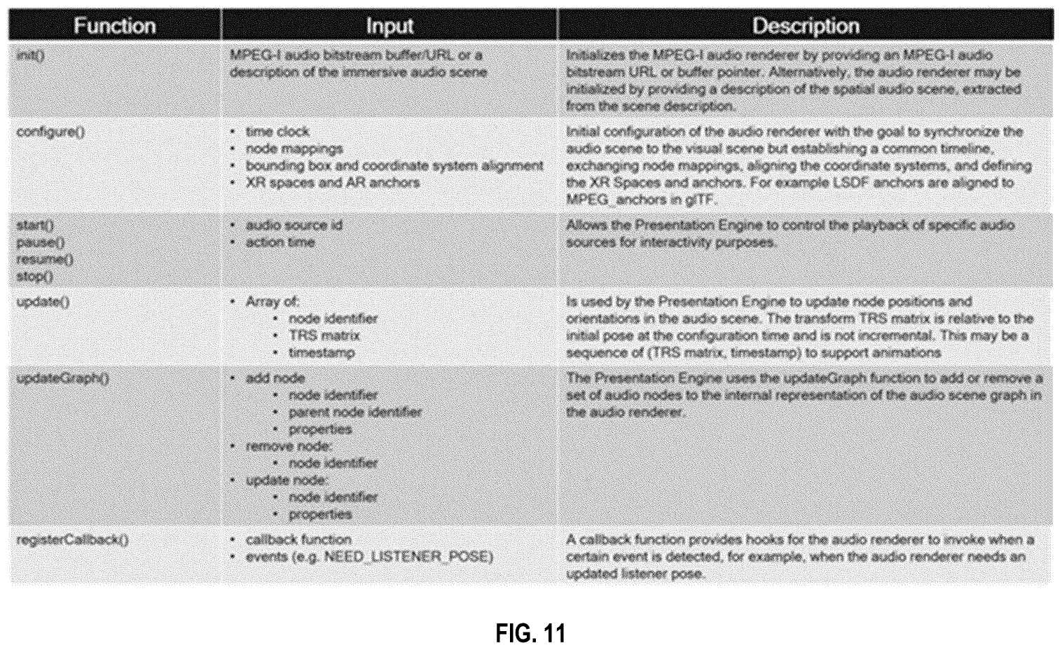

Audio unit 750 may expose an API 751, which may represent an example of the API 51. The API 751 may also conform to the MPEG-I audio standard, which includes the functions defined in the table shown in the example of FIG. 11 that accepts the specified inputs (and may adhere to the description listed in the table of FIG. 11).

Per the table shown in the example of FIG. 11, the API 751 may allow scene manager 23 to invoke an init function, a configure function, a start function, a pause function, a resume function, a stop function, an update function, an updateGraph function, and a registerCallback function. The init function may accept an MPEG-I audio bitstream buffer/uniform resource locator (ULR) or a description of the immersive audio scene, which allows scene manager 23 to initialize the MPEG-I audio renderer (represented by the audio unit 750 in the example of FIG. 7) by providing an MPEG-I audio bitstream URL or buffer pointer (or alternatively, the audio unit 750 may be initialized by providing a description of the spatial audio scene, extracted from a scene description).

The configure function may accept as inputs a time clock, a node mapping(s), a bounding box and coordinate system alignment, and/or XR spaces and AR anchors, which the scene manager 23 may invoke to specify an initial configuration of audio unit 750 with the potential goal to synchronize the audio scene to the visual scene but establishing a common timeline, exchanging node mappings, aligning the coordinate systems, and/or defining the XR spaces and anchors. As an example, listener spaces descriptor file (LSDF) anchors may be aligned to MPEG_anchors in gITF. The start, pause, resume, and/or stop functions may accept, as inputs, an audio source identifier (ID), and/or an action time, which allows the scene manager 23 to control the playback of specific audio sources for interactivity purposes.

The update function may accept, as inputs, an array of one or more of node identifier (ID), a translation, rotation, and scaling (TRS) matrix, and/or a timestamp. The scene manager 23 may invoke the update function to update node positions and orientations in the audio scene, while the scene manager 23 may invoke the update function to provide the TRS matrix, which is relative to the initial pose at configuration time and is not incremental, where this may be a sequence of (TRS matrix, timestamp) to possibly support animation.

The updateGraph function may accept, as inputs, an add node (specified by way of one or more of a node identifier, a parent node identifier, and/or one or more properties), a remove node (specified by way of the node identifier), and/or an update node (specified by way of one or more of the node identifier and/or one or more properties). The scene manager 23 may invoke the updateGraph function to add or remove a set of audio nodes to the internal representation of the audio scene graph in the audio renderer (of the audio unit 750).

The registerCallback function may accept, as inputs, a callback function and/or one or more events (e.g., NEED_LISTENER_POSE). The scene manager 23 may invoke this callback function to provide hooks for the audio renderer (of the audio unit 750) to invoke when a certain event is detected, where, e.g., when the audio renderer needs an updated listener pose.

In terms of node mapping, an implicit mapping mechanism may be assumed and it is the responsibility of the author to ensure proper and consistent node naming. In the example of gITF, the node name property is used for the mapping, where mapping may only be applied at the node level. A gITF node and an audio scene node are mapped together, which may mean that nodes are considered to be at the same hierarchical level (and not parent-child). For all nodes in the mapping (as one example), any changes to the nodes should trigger an update call (referencing that the scene manager 23 may invoke the update function in this example). The mapping may convey a transformation that is applied to the audio node to align both nodes, where this transformation may be provided as new in-band scene metadata in the MPEG-I audio stream (possibly as the TRS matrix referenced above). If no transform is provided, it is assumed that the audio transform and corresponding visual node are aligned or, alternatively, a transform is derived from the initial transforms at alignment time, where, e.g., TRS_visual⁻¹ multiplied by TRS_audio. The following table specifies how mappings may be signaled as syntax elements in the MPEG-I audio bitstream:

| | | |
|---|---|---|
| | No. of | |
| Syntax | bits | Mnemonic |

```
mappings( )
{
  mappingsCount = GetCount ( );
  for (int i = 0; i < mappingsCount; i++) {
    audioNodeId;
    visualNodeId;
    transformId;
  }
}
```

Other possible functions exposed by the API 751 may include functions related to an audio listener space and/or an XR space definition. For the audio listener space function(s), the scene manager 23 may obtain an understanding of the scene (e.g., a 3D reconstruction of the physical environment of the user) by interacting with the runtime system 720, where the scene manager 23 uses the update mechanism (or in other words, function) to update the LSDF. For the XR space definition function(s), the audio unit 750 (e.g., the audio renderer) may pass information about trackables that the audio renderer may track in the AR physical space, while the scene manager 23 may instruct the runtime system 720 to create a new application XR space and track the new application XR space, and retrieve or otherwise obtain the initial pose and share the initial pose with the audio render (of the audio unit 750). The audio renderer may retrieve the actual pose of the trackable in that XR space by using the callback function referenced above.

In terms of graph updates, nodes can be added to and removed from a graph, while one or more properties and components of a node may be updated. In addition, a node is added/removed based on events in the app, where adding nodes in some examples may refer to a user inserting a 3D asset into the scene (e.g., a new user joins the shared space) and removing nodes in some examples may refer to a user leaving a shared space. Node updates may affect the components of the node, where, for example, such updates may change a material of a node and/or change a geometry of the node.

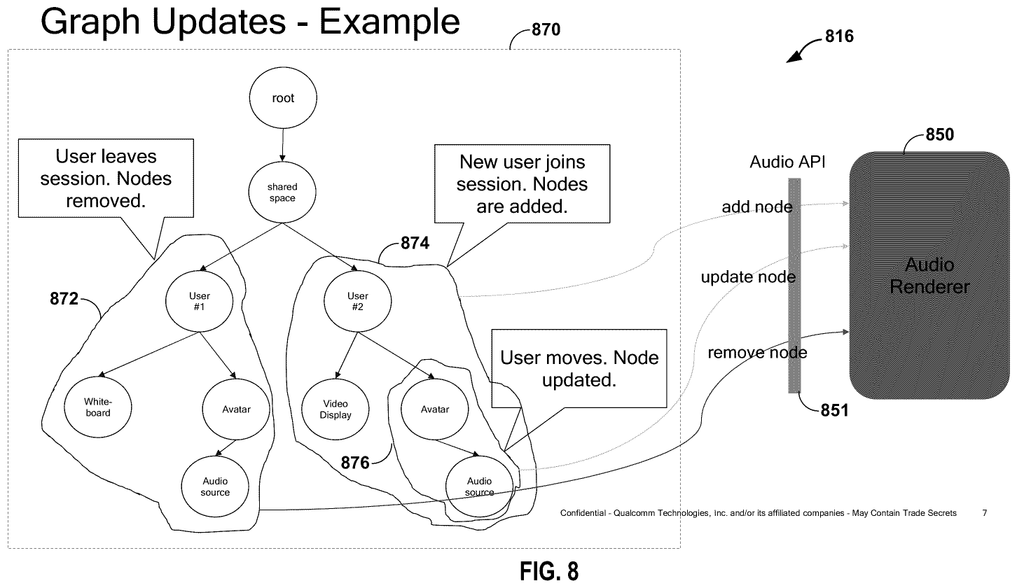

FIG. 8 is a diagram illustrating an example of the audio playback system in performing a graph update in accordance with various aspects of the techniques described in this disclosure. As shown in the example of FIG. 8, an audio playback system 816 may represent an example of the audio playback system 716 shown in the example of FIG. 7, showing how the scene manager 23 may invoke graph update functions via an API 851 (which may represent an example of the API 751) exposed by an audio renderer 850 (which may represent an example of the audio unit 750).

Responsive to a user #1 leaving a collaborative XR session (represented by a scene graph 870), the scene manager 23 (not shown in the example of FIG. 8) may invoke the update function noted above to remove nodes 872 (specifying a User #1 node, a Whiteboard node, an Avatar node, and an Audio source node) from the scene graph 870. Responsive to a user #2 joining the collaborative XR session, the scene manager 23 may invoke the update function to add nodes 874 (specifying a User #2 node, a Video Display node, an Avatar node, and an Audio source node) representative of User #2 to the scene graph 870, where the scene manager 23 may invoke the update function to update a subset of nodes 874 (denoted as nodes 876 specifying an Avatar node and an Audio source node) in the scene graph 870.

In terms of anchor alignments for AR and/or XR, the scene manager 23 may receive constructed scene information from the runtime system 720, where the scene manager 23 may then extract acoustic relevant information and create an LSDF. If an LSDF is already available at the audio renderer 850, a mapping of identified objects is performed to align the LSDF to the reconstructed physical space (which may match bounding boxes by rotating, translating and scaling according to the TRS matrix the LSDF acoustic environment geometry). Physical anchors are mapped and/or aligned with trackables for the anchors may for instance be the user's floor, a QR code, or a 2D image that are tracked by the runtime system 720.

While shown as including various nodes for both a visual element and an audio element, in some instances the scene graph may only include audio elements or only include video elements, where various relationships between other audio elements or other video elements may be provided by way of the scene graph. In some instances, a separate visual scene graph may be mapped to a separate audio scene graph to identify a common scene graph, such as that described above with respect to FIG. 8. In some examples, an audio only scene graph may be used to obtain the modified audio metadata (which, as noted below, may represent a single example of audio descriptive information). As such, all reference to audio metadata herein may also be referred to as audio descriptive information.

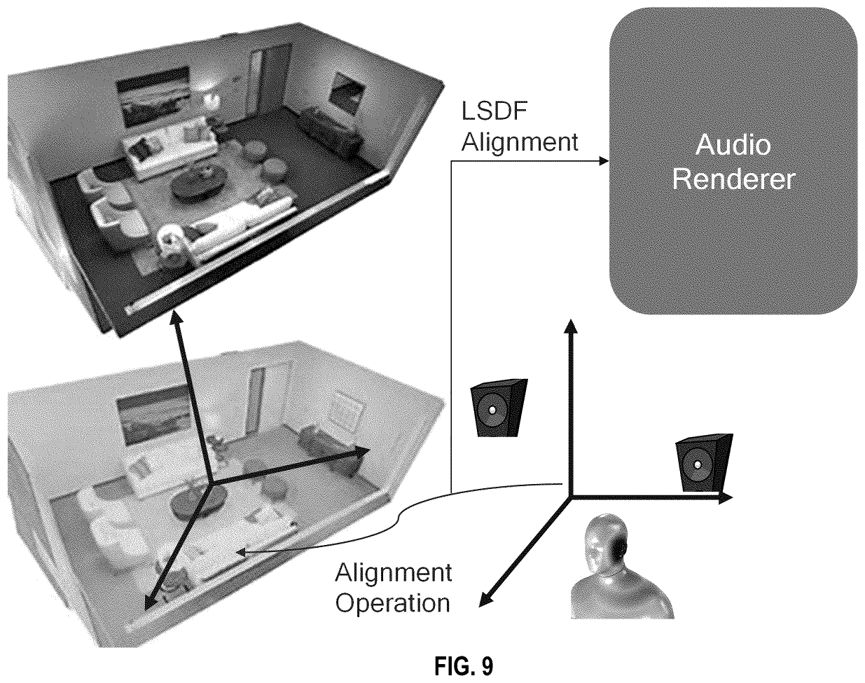

FIG. 9 is a diagram illustrating example listener space descriptor file (LSDF) alignment according to various aspects of the techniques described in this disclosure. In the example of FIG. 9, the runtime system 720 (shown in FIG. 7) may obtain a representation of the scene, where LSDF and LSDF updates are aligned to the audio coordinate system. Alignment may include matching trackables (e.g., QR code, image, floor, etc.) and/or scaling, rotation, and/or translation. LSDF is then used for audio rendering.

Although described with respect to audio metadata above, various aspects of the techniques described in this disclosure may be applied with respect to any type of audio descriptive information. While audio metadata may be specified in an audio bitstream representative of the audio element, audio descriptive information may be specified in various other side information, including via different transport formats associated with cellular communication standards, such as 3GPP 3G, 3GPP 4G, 3GPP 5G, 3GPP 6G, etc., various wireless networking standards, including personal area network standards (such as Bluetooth™), IEEE 802.11 family of standards, and the like, MPEG standards related to audio (e.g., MPEG-1, MPEG-2, MPEG-4, etc.). As such, audio descriptive information may be associated with the audio element but not necessarily transmitted in the same audio bitstream as the audio element, but instead as side information or other transport mechanisms.

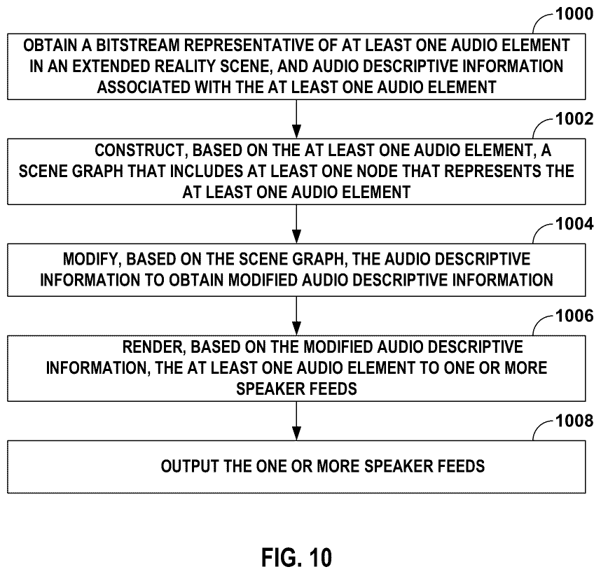

FIG. 10 is a flowchart illustrating example operation of the content consumer device of FIG. 1 in performing various aspects of the techniques described in this disclosure. As shown in the example of FIG. 10, the content consumer device 14 shown in the example of FIG. 1 may obtain a bitstream representative of at least one audio element in an extended reality scene, and audio descriptive information associated with the at least one audio element (1000).

The content consumer device 14 may also construct, based on the at least one audio element, a scene graph that includes at least one node that represents the at least one audio element (1002). The content consumer device 14 may further modifying, based on the scene graph, the audio descriptive information to obtain modified audio descriptive information (1004). The content consumer device 14 may next render, based on the modified audio descriptive information, the at least one audio element to one or more speaker feeds (1006), and output the one or more speaker feeds (1008).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, the VR device (or the streaming device) may communicate, using a network interface coupled to a memory of the VR/streaming device, exchange messages to an external device, where the exchange messages are associated with the multiple available representations of the soundfield. In some examples, the VR device may receive, using an antenna coupled to the network interface, wireless signals including data packets, audio packets, visual packets, or transport protocol data associated with the multiple available representations of the soundfield. In some examples, one or more microphone arrays may capture the soundfield.

In some examples, the multiple available representations of the soundfield stored to the memory device may include a plurality of object-based representations of the soundfield, higher order ambisonic representations of the soundfield, mixed order ambisonic representations of the soundfield, a combination of object-based representations of the soundfield with higher order ambisonic representations of the soundfield, a combination of object-based representations of the soundfield with mixed order ambisonic representations of the soundfield, or a combination of mixed order representations of the soundfield with higher order ambisonic representations of the soundfield.

In some examples, one or more of the soundfield representations of the multiple available representations of the soundfield may include at least one high-resolution region and at least one lower-resolution region, and wherein the selected presentation based on the steering angle provides a greater spatial precision with respect to the at least one high-resolution region and a lesser spatial precision with respect to the lower-resolution region.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, including fixed function processing circuitry and/or programmable processing circuitry, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

In this way, various aspects of the techniques may enable the following examples.

Example 1A. A device configured to process an audio bitstream, the device comprising: a memory configured to store a visual bitstream representative of at least one visual element in an extended reality scene and the audio bitstream representative of at least one audio element in the extended reality scene; and processing circuitry coupled of the memory and configured to: modify, based on the at least one visual element to the at least one audio element, audio metadata associated with the at least one audio element to obtain modified audio metadata; render, based on the modified audio metadata, the at least one audio element to one or more speaker feeds; and output the one or more speaker feeds.

Example 1.5A. The device of example 1A, wherein the processing circuitry is further configured to map, based on visual metadata associated with the at least one visual element and audio metadata associated with the at least one audio element, the at least one visual element to the at least one audio element.

Example 2A. The device of example 1A, wherein the visual metadata includes a pose of the at least one visual element in the extended reality scene, wherein the audio metadata includes a pose of the at least one audio element in the extended reality scene, and wherein the processing circuitry is configured to modify, based on the pose of the at least one visual element, the position of the at least one audio element to obtain to obtain a modified position of the at least one audio element in the extended reality scene.

Example 3A. The device of example 2A, wherein the modified pose of the at least one audio element differs from the pose of the at least one audio element.

Example 4A. The device of any combination of examples 2A and 3A, wherein the modified pose of the at least one audio element differs from the pose of the at least one audio element in terms of a rotational angle.

Example 5A. The device of any combination of examples 2A-4A, wherein the modified pose of the at least one audio element differs from the pose of the at least one audio element in terms of a translational distance.

Example 6A. The device of any combination of examples 1A-5A, wherein the at least one audio element includes a first audio element and a second audio element, wherein the processing circuitry is configured to map, based on visual metadata associated with the at least one visual element and audio metadata associated with the first audio element, the at least one visual element to the first audio element, wherein the processing circuitry is further configured to: determine that none of the at least one visual element maps to the second audio element; and render, based on the audio metadata associated with the second audio element, the second audio element to the one or more speaker feeds.

Example 7A. The device of any combination of examples 1A-6A, wherein the visual metadata includes an identifier that uniquely identifies the at least one visual element, wherein the audio metadata includes an identifier that uniquely identifies the at least one audio element, and wherein the processing circuitry is configured to map, based on the identifier that uniquely identifies the at least one visual element and the identifier that uniquely identifies the at least one audio element, the at least one visual element to the at least one audio element.

Example 8A. The device of example 7A, wherein the identifier that uniquely identifies the at least one visual element includes one or more of a visual element identifier and a visual element name, and wherein the identifier that uniquely identifies the at least one audio element includes one or more of an audio element identifier and an audio element name.

Example 9A. The device of any combination of examples 1A-8A, further comprising one or more speakers configured to reproduce, based on the one or more speaker feeds, a soundfield.

Example 10A. The device of any combination of examples 1A-9A, wherein the processing circuitry is further configured to execute a scene manager and an audio unit, wherein the scene manager is configured to map, based on the visual metadata associated with the at least one visual element and the audio metadata associated with the at least one audio element, the at least one visual element to the at least one audio element, and wherein the audio unit is configured to render, based on the modified audio metadata, the at least one audio element to the one or more speaker feeds.

Example 11A. The device of example 10A, wherein the scene manager is configured to modify, based on the mapping of the at least one visual element to the at least one audio element, the audio metadata to obtain the modified audio metadata, and wherein the scene manager is further configured to register, with the audio unit, a callback by which the audio unit is configured to request the modified audio metadata prior to rendering the at least one audio element.

Example 12A. The device of example 11A, wherein the scene manager registers the callback via an application programming interface exposed by the audio unit.

Example 13A. The device of any combination of examples 11A and 12A, wherein the audio unit is configured to request, responsive to the callback and prior to rendering the at least one audio element, the modified audio metadata.

Example 14A. The device of any combination of examples 11A-13A, wherein the audio unit is configured to request, responsive to the callback and prior to rendering each frame of audio data for the at least one audio element, the modified audio metadata.

Example 15A. The device of example 10A, wherein the processing circuitry is further configured to execute an audio processing unit, wherein the scene manager is configured to configure the audio processing unit to modify, based on the mapping of the at least one visual element to the at least one audio element, the audio metadata to obtain the modified audio metadata, and wherein the audio processing unit is configured to: replace, based on the configuration, the audio metadata in the audio bitstream with the modified audio metadata; and output the audio bitstream to the audio unit.

Example 16A. The device of example 15A, wherein the scene manager is configured, via an application programming interface exposed by the audio processing unit, to configure the audio processing unit to modify, based on the mapping of the at least one visual element to the at least one audio element, the audio metadata to obtain the modified audio metadata.

Example 17A. The device of example 10A, wherein the scene manager is further configured to: construct, based on the mapping of the at least one visual element to the at least one audio element, a scene graph that includes a parent node representative of the at least one visual element, and a child node that depends from the parent node and that represents the at least one audio element; and modify, based on the scene graph, the audio metadata to obtain modified audio metadata.

Example 18A. The device of example 17A, wherein the scene manager is further configured to output the modified audio metadata to the audio unit.

Example 19A. The device of example 17A, wherein the scene manager is further configured to output, via an application programming interface exposed by the audio unit, the modified audio metadata to the audio unit.

Example 20A. A method of processing at least one audio element, the method comprising: modifying, based on the at least one visual element to the at least one audio element, audio metadata associated with the at least one audio element to obtain modified audio metadata; rendering, based on the modified audio metadata, the at least one audio element to one or more speaker feeds; and outputting the one or more speaker feeds.

Example 21.5A. The method of example 1A, further comprising mapping, based on visual metadata associated with the at least one visual element and audio metadata associated with the at least one audio element, the at least one visual element to the at least one audio element.

Example 21A. The method of example 20A, wherein the visual metadata includes a pose of the at least one visual element in the extended reality scene, wherein the audio metadata includes a pose of the at least one audio element in the extended reality scene, and wherein modifying the audio metadata comprises modifying, based on the pose of the at least one visual element, the position of the at least one audio element to obtain to obtain a modified position of the at least one audio element in the extended reality scene.

Example 22A. The method of example 21A, wherein the modified pose of the at least one audio element differs from the pose of the at least one audio element.

Example 23A. The method of any combination of example 21A and 22A, wherein the modified pose of the at least one audio element differs from the pose of the at least one audio element in terms of a rotational angle.

Example 24A. The method of any combination of examples 21A-23A, wherein the modified pose of the at least one audio element differs from the pose of the at least one audio element in terms of a translational distance.

Example 25A. The method of any combination of examples 20A-24A, wherein the at least one audio element includes a first audio element and a second audio element, wherein the method further comprises: mapping, based on visual metadata associated with the at least one visual element and audio metadata associated with the first audio element, the at least one visual element to the first audio element; determining that none of the at least one visual element maps to the second audio element; and rendering, based on the audio metadata associated with the second audio element, the second audio element to the one or more speaker feeds.

Example 26A. The method of any combination of examples 20A-25A, wherein the visual metadata includes an identifier that uniquely identifies the at least one visual element, wherein the audio metadata includes an identifier that uniquely identifies the at least one audio element, and wherein the method further comprises mapping, based on the identifier that uniquely identifies the at least one visual element and the identifier that uniquely identifies the at least one audio element, the at least one visual element to the at least one audio element.

Example 27A. The method of example 26A, wherein the identifier that uniquely identifies the at least one visual element includes one or more of a visual element identifier and a visual element name, and wherein the identifier that uniquely identifies the at least one audio element includes one or more of an audio element identifier and an audio element name.

Example 28A. The method of any combination of examples 20A-27A, further comprising reproducing, by one or more speakers and based on the one or more speaker feeds, a soundfield.

Example 29A. The method of any combination of examples 20A-28A, further comprising executing a scene manager and an audio subsystem, wherein the scene manager is configured to map, based on the visual metadata associated with the at least one visual element and the audio metadata associated with the at least one audio element, the at least one visual element to the at least one audio element, and wherein the audio unit is configured to render, based on the modified audio metadata, the at least one audio element to the one or more speaker feeds.

Example 30A. The method of example 29A, wherein modifying the audio metadata comprises executing the scene manager to modify, based on the mapping of the at least one visual element to the at least one audio element, the audio metadata to obtain the modified audio metadata, and wherein the method further comprises registering, by the scene manager and with the audio unit, a callback by which the audio unit is configured to request the modified audio metadata prior to rendering the at least one audio element.

Example 31A. The method of example 30A, further comprising registering the callback via an application programming interface exposed by the audio unit.

Example 32A. The method of any combination of examples 30A and 31A, further comprising requesting, responsive to the callback and prior to rendering the at least one audio element, the modified audio metadata.

Example 33A. The method of any combination of examples 30A-32A, further comprising requesting, responsive to the callback and prior to rendering each frame of audio data for the at least one audio element, the modified audio metadata.

Example 34A. The method of example 29A, further comprising configuring the audio processing unit to modify, based on the mapping of the at least one visual element to the at least one audio element, the audio metadata to obtain the modified audio metadata, and wherein the method further comprises: replacing, based on the configuration, the audio metadata in the audio bitstream with the modified audio metadata; and outputting the audio bitstream to the audio unit.

Example 35A. The method of example 34A, wherein configuring the audio processing unit comprises configuring, via an application programming interface exposed by the audio processing unit, to configure the audio processing unit to modify, based on the mapping of the at least one visual element to the at least one audio element, the audio metadata to obtain the modified audio metadata.

Example 36A. The method of example 29A, further comprising: constructing, based on the mapping of the at least one visual element to the at least one audio element, a scene graph that includes a parent node representative of the at least one visual element, and a child node that depends from the parent node and that represents the at least one audio element; and modifying, based on the scene graph, the audio metadata to obtain modified audio metadata.

Example 37A. The method of example 36A, further comprising outputting the modified audio metadata to the audio unit.

Example 38A. The method of example 36A, further comprising outputting, via an application programming interface exposed by the audio unit, the modified audio metadata to the audio unit.

Example 39A. A non-transitory computer-readable storage medium having instructions stored thereon that, when executed, cause one or more processors to: modify, based on the at least one visual element to the at least one audio element, audio metadata associated with the at least one audio element to obtain modified audio metadata; render, based on the modified audio metadata, the at least one audio element to one or more speaker feeds; and output the one or more speaker feeds.

Example 1B. A device configured to process an audio bitstream, the device comprising: a memory configured to store a visual bitstream representative of at least one visual element in an extended reality scene and the audio bitstream representative of at least one audio element in the extended reality scene; and processing circuitry coupled of the memory and configured to execute a scene manager and an audio unit, wherein the scene manager is configured to: modify, based on the at least one visual element to the at least one audio element, audio metadata associated with the at least one audio element to obtain modified audio metadata; and register, with the audio unit, a callback by which the audio unit is configured to request the modified audio metadata prior to rendering the at least one audio element, and wherein the audio unit is configured to: render, based on the modified audio metadata, the at least one audio element to one or more speaker feeds; and output the one or more speaker feeds.

Example 1.5B. The device of example 1B, wherein the scene manager is configured to map, based on visual metadata associated with the at least one visual element and the audio metadata associated with the at least one audio element, the at least one visual element to the at least one audio element.

Example 2B. The device of example 1B, wherein the visual metadata includes a position of the at least one visual element in the extended reality scene, wherein the audio metadata includes a position of the at least one audio element in the extended reality scene, and wherein the scene manager is configured to modify, based on the position of the at least one visual element, the position of the at least one audio element to obtain to obtain a modified position of the at least one audio element in the extended reality scene.

Example 3B. The device of example 2B, wherein the modified position of the at least one audio element differs from the position of the at least one audio element.

Example 4B. The device of any combination of example 2B and 3B, wherein the modified position of the at least one audio element differs from the position of the at least one audio element in terms of a rotational angle.

Example 5B. The device of any combination of examples 2B-4B, wherein the modified position of the at least one audio element differs from the position of the at least one audio element in terms of a translational distance.

Example 6B. The device of any combination of examples 1B-5B, wherein the at least one audio element includes a first audio element and a second audio element, wherein the scene manager is configured to map, based on visual metadata associated with the at least one visual element and audio metadata associated with the first audio element, the at least one visual element to the first audio element, wherein the scene manager is further configured to: determine that none of the at least one visual element maps to the second audio element; and render, based on the audio metadata associated with the second audio element, the second audio element to the one or more speaker feeds.

Example 7B. The device of any combination of examples 1B-6B, wherein the visual metadata includes an identifier that uniquely identifies the at least one visual element, wherein the audio metadata includes an identifier that uniquely identifies the at least one audio element, and wherein the scene manager is configured to map, based on the identifier that uniquely identifies the at least one visual element and the identifier that uniquely identifies the at least one audio element, the at least one visual element to the at least one audio element.

Example 8B. The device of example 7B, wherein the identifier that uniquely identifies the at least one visual element includes one or more of a visual element identifier and a visual element name, and wherein the identifier that uniquely identifies the at least one audio element includes one or more of an audio element identifier and an audio element name.

Example 9B. The device of any combination of examples 1B-8B, further comprising one or more speakers configured to reproduce, based on the one or more speaker feeds, a soundfield.

Example 10B. The device of any combination of examples 1B-9B, wherein the scene manager registers the callback via an application programming interface exposed by the audio unit.

Example 11B. The device of any combination of examples 1B-10B, wherein the audio unit is configured to request, responsive to the callback and prior to rendering the at least one audio element, the modified audio metadata.

Example 12B. The device of any combination of examples 1B-11B, wherein the audio unit is configured to request, responsive to the callback and prior to rendering each frame of audio data for the at least one audio element, the modified audio metadata.

Example 13B. A method of processing at least one audio element, the method comprising: modifying, by a scene manager executed by processing circuitry and based the at least one visual element and the at least one audio element, audio metadata associated with the at least one audio element to obtain modified audio metadata; rendering, by an audio unit executed by the processing circuitry and based on the modified audio metadata, the at least one audio element to one or more speaker feeds; and outputting, by the audio unit, the one or more speaker feeds.

Example 13.5B. The method of example 13B, further comprising mapping, by the scene manager and based on visual metadata associated with at least one visual element and the audio metadata associated with the at least one audio element, the at least one visual element to the at least one audio element;

Example 14B. The method of example 13B, wherein the visual metadata includes a position of the at least one visual element in the extended reality scene, wherein the audio metadata includes a position of the at least one audio element in the extended reality scene, and wherein modifying the audio metadata comprises modifying, based on the position of the at least one visual element, the position of the at least one audio element to obtain to obtain a modified position of the at least one audio element in the extended reality scene.

Example 15B. The method of example 14B, wherein the modified position of the at least one audio element differs from the position of the at least one audio element.

Example 16B. The method of any combination of example 14B and 15B, wherein the modified position of the at least one audio element differs from the position of the at least one audio element in terms of a rotational angle.

Example 17B. The method of any combination of examples 14B-16B, wherein the modified position of the at least one audio element differs from the position of the at least one audio element in terms of a translational distance.

Example 18B. The method of any combination of examples 13B-17B, wherein the at least one audio element includes a first audio element and a second audio element, wherein the method further comprises: mapping, based on visual metadata associated with the at least one visual element and audio metadata associated with the first audio element, the at least one visual element to the first audio element, determining that none of the at least one visual element maps to the second audio element; and rendering, based on the audio metadata associated with the second audio element, the second audio element to the one or more speaker feeds.

Example 19B. The method of any combination of examples 13B-18B, wherein the visual metadata includes an identifier that uniquely identifies the at least one visual element, wherein the audio metadata includes an identifier that uniquely identifies the at least one audio element, and wherein the method further comprises mapping, based on the identifier that uniquely identifies the at least one visual element and the identifier that uniquely identifies the at least one audio element, the at least one visual element to the at least one audio element.

Example 20B. The method of example 19B, wherein the identifier that uniquely identifies the at least one visual element includes one or more of a visual element identifier and a visual element name, and wherein the identifier that uniquely identifies the at least one audio element includes one or more of an audio element identifier and an audio element name.

Example 21B. The method of any combination of examples 13B-20B, further comprising reproducing, by one or more speakers and based on the one or more speaker feeds, a soundfield.

Example 22B. The method of any combination of examples 13B-21B, further comprising registering the callback via an application programming interface exposed by the audio unit.

Example 23B. The method of any combination of examples 13B-22B, further comprising requesting, responsive to the callback and prior to rendering the at least one audio element, the modified audio metadata.

Example 24B. The method of any combination of examples 13B-23B, further comprising requesting, responsive to the callback and prior to rendering each frame of audio data for the at least one audio element, the modified audio metadata.

Example 25B. A non-transitory computer-readable storage medium having instructions stored thereon that, when executed, cause one or more processors to: execute a scene manager configured to modify, based on the at least one visual element and the at least one audio element, audio metadata associated with the at least one audio element to obtain modified audio metadata; and execute an audio unit configured to: render, based on the modified audio metadata, the at least one audio element to one or more speaker feeds; and output the one or more speaker feeds.

Example 1C. A device configured to process an audio bitstream, the device comprising: a memory configured to store a visual bitstream representative of at least one visual element in an extended reality scene and the audio bitstream representative of at least one audio element in the extended reality scene; and processing circuitry coupled of the memory and configured to execute a scene manager, an audio processing unit, and an audio unit, wherein the scene manager is configured to: modify, based on the at least one visual element and the at least one audio element, audio metadata associated with the at least one audio element to obtain modified audio metadata; and configure the audio processing unit to modify, based on the mapping of the at least one visual element to the at least one audio element, the audio metadata to obtain the modified audio metadata, wherein the audio processing unit is configured to: replace, based on the configuration, the audio metadata in the audio bitstream with the modified audio metadata; and output the audio bitstream to the audio unit, and wherein the audio unit is configured to: render, based on the modified audio metadata, the at least one audio element to one or more speaker feeds; and output the one or more speaker feeds.

Example 2C. The device of example 1C, wherein the visual metadata includes a position of the at least one visual element in the extended reality scene, wherein the audio metadata includes a position of the at least one audio element in the extended reality scene, and wherein the scene manager is configured to modify, based on the position of the at least one visual element, the position of the at least one audio element to obtain to obtain a modified position of the at least one audio element in the extended reality scene.

Example 3C. The device of example 2C, wherein the modified position of the at least one audio element differs from the position of the at least one audio element.

Example 4C. The device of any combination of example 2C and 3C, wherein the modified position of the at least one audio element differs from the position of the at least one audio element in terms of a rotational angle.

Example 5C. The device of any combination of examples 2C-4C, wherein the modified position of the at least one audio element differs from the position of the at least one audio element in terms of a translational distance.

Example 6C. The device of any combination of examples 1C-5C, wherein the at least one audio element includes a first audio element and a second audio element, wherein the scene manager is further configured to: map, based on visual metadata associated with the at least one visual element and the audio metadata associated with the first audio element, the at least one visual element to the first audio element; determine that none of the at least one visual element maps to the second audio element; and render, based on the audio metadata associated with the second audio element, the second audio element to the one or more speaker feeds.

Example 7C. The device of any combination of examples 1C-6C, wherein the visual metadata includes an identifier that uniquely identifies the at least one visual element, wherein the audio metadata includes an identifier that uniquely identifies the at least one audio element, and wherein the scene manager is configured to map, based on the identifier that uniquely identifies the at least one visual element and the identifier that uniquely identifies the at least one audio element, the at least one visual element to the at least one audio element.

Example 8C. The device of example 7C, wherein the identifier that uniquely identifies the at least one visual element includes one or more of a visual element identifier and a visual element name, and wherein the identifier that uniquely identifies the at least one audio element includes one or more of an audio element identifier and an audio element name.

Example 9C. The device of any combination of examples 1C-8C, further comprising one or more speakers configured to reproduce, based on the one or more speaker feeds, a soundfield.

Example 10C. The device of any combination of examples 1C-9C, wherein the scene manager is configured, via an application programming interface exposed by the audio processing unit, to configure the audio processing unit to modify, based on the mapping of the at least one visual element to the at least one audio element, the audio metadata to obtain the modified audio metadata.

Example 11C. A method of processing at least one audio element, the method comprising: modifying, by a scene manager executed by processing circuitry and based on the at least one visual element and the at least one audio element, audio metadata associated with the at least one audio element to obtain modified audio metadata; configuring, by the scene manager, an audio processing unit to modify, based on the mapping of the at least one visual element to the at least one audio element, the audio metadata to obtain the modified audio metadata, replacing, by the audio processing unit and based on the configuration, the audio metadata in the audio bitstream with the modified audio metadata; and outputting, by the audio processing unit, the audio bitstream to an audio unit executed by the processing circuitry; rendering, by the audio unit and based on the modified audio metadata, the at least one audio element to one or more speaker feeds; and outputting, by the audio unit, the one or more speaker feeds.

Example 11.5C. The method of example 11C, further comprising mapping, by the scene manager and based on visual metadata associated with at least one visual element and the audio metadata associated with the at least one audio element, the at least one visual element to the at least one audio element.

Example 12C. The method of example 11C, wherein the visual metadata includes a position of the at least one visual element in the extended reality scene, wherein the audio metadata includes a position of the at least one audio element in the extended reality scene, and wherein modifying the audio metadata comprises modifying, based on the position of the at least one visual element, the position of the at least one audio element to obtain to obtain a modified position of the at least one audio element in the extended reality scene.

Example 13C. The method of example 12C, wherein the modified position of the at least one audio element differs from the position of the at least one audio element.

Example 14C. The method of any combination of example 12C and 13C, wherein the modified position of the at least one audio element differs from the position of the at least one audio element in terms of a rotational angle.

Example 15C. The method of any combination of examples 12C-14C, wherein the modified position of the at least one audio element differs from the position of the at least one audio element in terms of a translational distance.

Example 16C. The method of any combination of examples 11C-15C, wherein the at least one audio element includes a first audio element and a second audio element, wherein the method further comprises: mapping, based on visual metadata associated with the at least one visual element and the audio metadata associated with the first audio element, the at least one visual element to the first audio element; determining that none of the at least one visual element maps to the second audio element; and rendering, based on the audio metadata associated with the second audio element, the second audio element to the one or more speaker feeds.

Example 17C. The method of any combination of examples 11C-16C, wherein the visual metadata includes an identifier that uniquely identifies the at least one visual element, wherein the audio metadata includes an identifier that uniquely identifies the at least one audio element, and wherein the method further comprises mapping, based on the identifier that uniquely identifies the at least one visual element and the identifier that uniquely identifies the at least one audio element, the at least one visual element to the at least one audio element.

Example 18C. The method of example 17C, wherein the identifier that uniquely identifies the at least one visual element includes one or more of a visual element identifier and a visual element name, and wherein the identifier that uniquely identifies the at least one audio element includes one or more of an audio element identifier and an audio element name.

Example 19C. The method of any combination of examples 11C-18C, further comprising reproducing, by one or more speakers and based on the one or more speaker feeds, a soundfield.

Example 20C. The method of any combination of examples 11C-19C, wherein configuring the audio processing unit comprises configuring, via an application programming interface exposed by the audio processing unit, the audio processing unit to modify, based on the mapping of the at least one visual element to the at least one audio element, the audio metadata to obtain the modified audio metadata.

Example 21C. A non-transitory computer-readable storage medium having instructions stored thereon that, when executed, cause one or more processors to: execute a scene manager configured to modify, based on the at least one visual element and the at least one audio element, the audio metadata to obtain modified audio metadata, and configure an audio processing unit to modify, based on the mapping of the at least one visual element to the at least one audio element, the audio metadata to obtain the modified audio metadata; execute the audio processing unit to replace, based on the configuration, the audio metadata in the audio bitstream with the modified audio metadata, and output the audio bitstream to the audio unit; and execute an audio unit configured to render, based on the modified audio metadata, the at least one audio element to one or more speaker feeds, and output the one or more speaker feeds.

Example 1D. A device configured to process an audio bitstream, the device comprising: a memory configured to store a visual bitstream representative of at least one visual element in an extended reality scene and the audio bitstream representative of at least one audio element in the extended reality scene, the audio bitstream includes audio metadata; and processing circuitry coupled of the memory and configured to execute a scene manager and an audio unit, wherein the scene manager is configured to: construct, based on the at least one visual element and the at least one audio element, a scene graph that includes a parent node representative of the at least one visual element, and a child node that depends from the parent node and that represents the at least one audio element; and modify, based on the scene graph, the audio metadata to obtain modified audio metadata, and wherein the audio unit is configured to: render, based on the modified audio metadata, the at least one audio element to one or more speaker feeds; and output the one or more speaker feeds.

Example 1.5D. The device of example 1D, wherein the scene manager is further configured to map, based on visual metadata associated with the at least one visual element and the audio metadata associated with the at least one audio element, the at least one visual element to the at least one audio element;

Example 2D. The device of example 1D, wherein the visual metadata includes a position of the at least one visual element in the extended reality scene, wherein the audio metadata includes a position of the at least one audio element in the extended reality scene, and wherein the scene manager is configured to modify, based on the position of the at least one visual element, the position of the at least one audio element to obtain to obtain a modified position of the at least one audio element in the extended reality scene.

Example 3D. The device of example 2D, wherein the modified position of the at least one audio element differs from the position of the at least one audio element.

Example 4D. The device of any combination of example 2D and 3D, wherein the modified position of the at least one audio element differs from the position of the at least one audio element in terms of a rotational angle.

Example 5D. The device of any combination of examples 2D-4D, wherein the modified position of the at least one audio element differs from the position of the at least one audio element in terms of a translational distance.

Example 6D. The device of any combination of examples 1D-5D, wherein the at least one audio element includes a first audio element and a second audio element, and wherein the scene manager is further configured to: map, based on visual metadata associated with the at least one visual element and audio metadata associated with the first audio element, the at least one visual element to the first audio element; determine that none of the at least one visual element maps to the second audio element; and render, based on the audio metadata associated with the second audio element, the second audio element to the one or more speaker feeds.

Example 7D. The device of any combination of examples 1D-6D, wherein the visual metadata includes an identifier that uniquely identifies the at least one visual element, wherein the audio metadata includes an identifier that uniquely identifies the at least one audio element, and wherein the scene manager is configured to map, based on the identifier that uniquely identifies the at least one visual element and the identifier that uniquely identifies the at least one audio element, the at least one visual element to the at least one audio element.

Example 8D. The device of example 7D, wherein the identifier that uniquely identifies the at least one visual element includes one or more of a visual element identifier and a visual element name, and wherein the identifier that uniquely identifies the at least one audio element includes one or more of an audio element identifier and an audio element name.

Example 9D. The device of any combination of examples 1D-8D, further comprising one or more speakers configured to reproduce, based on the one or more speaker feeds, a soundfield.

Example 10D. The device of any combination of examples 1D-9D, wherein the scene manager is further configured to output the modified audio metadata to the audio unit.

Example 11D. The device of any combination of examples 1D-9D, wherein the scene manager is further configured to output, via an application programming interface exposed by the audio unit, the modified audio metadata to the audio unit.

Example 12D. A method of processing at least one audio element, the method comprising: constructing, by a scene manager executed by processing circuitry and based on the at least one visual element and the at least one audio element, a scene graph that includes a parent node representative of the at least one visual element, and a child node that depends from the parent node and that represents the at least one audio element; modifying, by the scene manager and based on the scene graph, audio metadata associated with the at least one audio element to obtain modified audio metadata; rendering, by an audio unit executed by the processing circuitry and based on the modified audio metadata, the at least one audio element to one or more speaker feeds; and outputting, by the audio unit, the one or more speaker feeds.

Example 12.5D. The method of example 12D, further comprising mapping, by the scene manager and based on visual metadata associated with at least one visual element and the audio metadata associated with the at least one audio element, the at least one visual element to the at least one audio element.

Example 13D. The method of example 12D, wherein the visual metadata includes a position of the at least one visual element in the extended reality scene, wherein the audio metadata includes a position of the at least one audio element in the extended reality scene, and wherein modifying the audio metadata comprises modifying, based on the position of the at least one visual element, the position of the at least one audio element to obtain to obtain a modified position of the at least one audio element in the extended reality scene.

Example 14D. The method of example 13D, wherein the modified position of the at least one audio element differs from the position of the at least one audio element.

Example 15D. The method of any combination of example 13D and 14D, wherein the modified position of the at least one audio element differs from the position of the at least one audio element in terms of a rotational angle.

Example 16D. The method of any combination of examples 13D-15D, wherein the modified position of the at least one audio element differs from the position of the at least one audio element in terms of a translational distance.

Example 17D. The method of any combination of examples 12D-16D, wherein the at least one audio element includes a first audio element and a second audio element, and wherein the method further comprises: mapping, based on visual metadata associated with the at least one visual element and audio metadata associated with the first audio element, the at least one visual element to the first audio element; and determining that none of the at least one visual element maps to the second audio element; and rendering, based on the audio metadata associated with the second audio element, the second audio element to the one or more speaker feeds.

Example 18D. The method of any combination of examples 12D-17D, wherein the visual metadata includes an identifier that uniquely identifies the at least one visual element, wherein the audio metadata includes an identifier that uniquely identifies the at least one audio element, and wherein the method further comprises mapping, based on the identifier that uniquely identifies the at least one visual element and the identifier that uniquely identifies the at least one audio element, the at least one visual element to the at least one audio element.

Example 19D. The method of example 18D, wherein the identifier that uniquely identifies the at least one visual element includes one or more of a visual element identifier and a visual element name, and wherein the identifier that uniquely identifies the at least one audio element includes one or more of an audio element identifier and an audio element name.

Example 20D. The method of any combination of examples 12D-19D, further comprising reproducing, by one or more speakers and based on the one or more speaker feeds, a soundfield.

Example 21D. The method of any combination of examples 12D-20D, further comprising outputting the modified audio metadata to the audio unit.

Example 22D. The method of any combination of examples 12D-20D, further comprising outputting, via an application programming interface exposed by the audio unit, the modified audio metadata to the audio unit.

Example 23D. A non-transitory computer-readable storage medium having instructions stored thereon that, when executed, cause one or more processors to: execute a scene manager configured to: construct, by the scene manager and based on the at least one visual element and the at least one audio element, a scene graph that includes a parent node representative of the at least one visual element, and a child node that depends from the parent node and that represents the at least one audio element; and modify, by the scene manager and based on the scene graph, the audio metadata to obtain modified audio metadata; and execute an audio unit configured to: render, based on the modified audio metadata, the at least one audio element to one or more speaker feeds; and output the one or more speaker feeds.

Example 1E. A device configured to process a bitstream, the device comprising: a memory configured to store the bitstream representative of at least one audio element in the extended reality scene, and audio descriptive information associated with the at least one audio element; and processing circuitry coupled of the memory and configured to execute a scene manager and an audio unit, wherein the scene manager is configured to: construct, based on the at least one audio element, a scene graph that includes at least one node that represents the at least one audio element; and modify, based on the scene graph, the audio descriptive information to obtain modified audio descriptive information, and wherein the audio unit is configured to: render, based on the modified audio descriptive information, the at least one audio element to one or more speaker feeds; and output the one or more speaker feeds.

Example 2E. The device of example 1E, wherein the scene manager is further configured to obtain at least one visual element, and wherein the scene manager is configured to construct, based on the at least one audio element and the at least one video element, the scene graph that includes a parent node representative of the at least one visual element, and a child node that depends from the parent node and that represents the at least one audio element.

Example 3E. The device of example 2E, wherein the scene manager is configured to align the at least one visual element and the at least one audio element when constructing the scene graph.

Example 4E. The device of example 1E-3E, wherein the scene manager is further configured to update the scene graph to add, remove, or edit the at least one node that represents the at least one audio element.

Example 5E. The device of example 2E, wherein the scene manager is further configured to map, based on visual descriptive information associated with the at least one visual element and the audio descriptive information associated with the at least one audio element, the at least one visual element to the at least one audio element;

Example 6E. The device of example 5E, wherein the visual descriptive information includes a position of the at least one visual element in the extended reality scene, wherein the audio descriptive information includes a position of the at least one audio element in the extended reality scene, and wherein the scene manager is configured to modify, based on the position of the at least one visual element, the position of the at least one audio element to obtain to obtain a modified position of the at least one audio element in the extended reality scene.

Example 7E. The device of example 6E, wherein the modified position of the at least one audio element differs from the position of the at least one audio element.

Example 8E. The device of any combination of example 6E and 7E, wherein the modified position of the at least one audio element differs from the position of the at least one audio element in terms of a rotational angle.

Example 9E. The device of any combination of examples 6E-8E, wherein the modified position of the at least one audio element differs from the position of the at least one audio element in terms of a translational distance.

Example 10E. The device of any combination of examples 5E-9E, wherein the at least one audio element includes a first audio element and a second audio element, wherein the scene manager is further configured to: map, based on visual descriptive information associated with the at least one visual element and audio descriptive information associated with the first audio element, the at least one visual element to the first audio element; determine that none of the at least one visual element maps to the second audio element; and render, based on the audio descriptive information associated with the second audio element, the second audio element to the one or more speaker feeds.

Example 11E. The device of any combination of examples 5E-10E, wherein the visual descriptive information includes an identifier that uniquely identifies the at least one visual element, wherein the audio descriptive information includes an identifier that uniquely identifies the at least one audio element, and wherein the scene manager is configured to map, based on the identifier that uniquely identifies the at least one visual element and the identifier that uniquely identifies the at least one audio element, the at least one visual element to the at least one audio element.

Example 12E. The device of example 11E, wherein the identifier that uniquely identifies the at least one visual element includes one or more of a visual element identifier and a visual element name, and wherein the identifier that uniquely identifies the at least one audio element includes one or more of an audio element identifier and an audio element name.

Example 13E. The device of any combination of examples 5E-12E, further comprising one or more speakers configured to reproduce, based on the one or more speaker feeds, a soundfield.

Example 14E. The device of any combination of examples 5E-13E, wherein the scene manager is further configured to output the modified audio metadata to the audio unit.

Example 15E. The device of any combination of examples 5E-13E, wherein the scene manager is further configured to output, via an application programming interface exposed by the audio unit, the modified audio metadata to the audio unit.

Example 15.5E. The device of any combination of examples 1E-15E, wherein the bitstream is transmitted according to one or more of a wireless network protocol, a personal area network protocol, and a cellular network protocol.

Example 16E. A method comprising: obtaining a bitstream representative of at least one audio element in an extended reality scene, and audio descriptive information associated with the at least one audio element; and constructing, based on the at least one audio element, a scene graph that includes at least one node that represents the at least one audio element; and modifying, based on the scene graph, the audio descriptive information to obtain modified audio descriptive information, and rendering, based on the modified audio descriptive information, the at least one audio element to one or more speaker feeds; and outputting the one or more speaker feeds.

Example 17E. The method of example 16E, further comprising obtaining at least one visual element, wherein constructing the scene graph includes constructing, based on the at least one audio element and the at least one video element, the scene graph that includes a parent node representative of the at least one visual element, and a child node that depends from the parent node and that represents the at least one audio element.

Example 18E. The method of example 15E, wherein constructing the scene graph includes aligning the at least one visual element and the at least one audio element.

Example 19E. The method of example 16E-18E, further comprising updating the scene graph to add, remove, or edit the at least one node that represents the at least one audio element.

Example 20E. The method of example 17E, further comprising mapping, based on visual descriptive information associated with the at least one visual element and the audio descriptive information associated with the at least one audio element, the at least one visual element to the at least one audio element;

Example 21E. The method of example 20E, wherein the visual descriptive information includes a position of the at least one visual element in the extended reality scene, wherein the audio descriptive information includes a position of the at least one audio element in the extended reality scene, and wherein modifying the audio descriptive information comprises modifying, based on the position of the at least one visual element, the position of the at least one audio element to obtain to obtain a modified position of the at least one audio element in the extended reality scene.

Example 22E. The method of example 21E, wherein the modified position of the at least one audio element differs from the position of the at least one audio element.

Example 23E. The method of any combination of examples 21E and 22E, wherein the modified position of the at least one audio element differs from the position of the at least one audio element in terms of a rotational angle.

Example 24E. The method of any combination of examples 21E-23E, wherein the modified position of the at least one audio element differs from the position of the at least one audio element in terms of a translational distance.

Example 25E. The method of any combination of examples 20E-24E, wherein the at least one audio element includes a first audio element and a second audio element, and wherein the method further comprises: mapping, based on visual descriptive information associated with the at least one visual element and audio descriptive information associated with the first audio element, the at least one visual element to the first audio element; determining that none of the at least one visual element maps to the second audio element; and rendering, based on the audio descriptive information associated with the second audio element, the second audio element to the one or more speaker feeds.

Example 26E. The method of any combination of examples 20E-25E, wherein the visual descriptive information includes an identifier that uniquely identifies the at least one visual element, wherein the audio descriptive information includes an identifier that uniquely identifies the at least one audio element, and wherein mapping the at least one visual element to the at least one audio element comprises mapping, based on the identifier that uniquely identifies the at least one visual element and the identifier that uniquely identifies the at least one audio element, the at least one visual element to the at least one audio element.

Example 27E. The method of example 26E, wherein the identifier that uniquely identifies the at least one visual element includes one or more of a visual element identifier and a visual element name, and wherein the identifier that uniquely identifies the at least one audio element includes one or more of an audio element identifier and an audio element name.

Example 28E. The method of any combination of examples 20E-27E, further comprising outputting the modified audio metadata to an audio unit.

Example 29E. The device of any combination of examples 20E-27E, further comprising output, via an application programming interface exposed by the audio unit, the modified audio metadata to the audio unit.

Example 29.5E. The device of any combination of examples 20E-27E, wherein the bitstream is transmitted according to one or more of a wireless network protocol, a personal area network protocol, and a cellular network protocol.

Example 30E. A non-transitory computer-readable medium having stored thereon instructions that, when executed, cause processing circuitry to: obtain a bitstream representative of at least one audio element in an extended reality scene, and audio descriptive information associated with the at least one audio element; and construct, based on the at least one audio element, a scene graph that includes at least one node that represents the at least one audio element; and modify, based on the scene graph, the audio descriptive information to obtain modified audio descriptive information, and render, based on the modified audio descriptive information, the at least one audio element to one or more speaker feeds; and output the one or more speaker feeds.

Various examples have been described. These and other examples are within the scope of the following claims.

What is claimed is:

1. A device configured to process a bitstream, the device comprising:
a memory configured to store the bitstream representative of at least one audio element in an extended reality scene, and audio descriptive information associated with the at least one audio element; and
processing circuitry coupled of the memory and configured to execute a scene manager and an audio unit,
wherein the scene manager is configured to:
construct, based on the at least one audio element, a scene graph that includes at least one node that represents the at least one audio element; and
modify, based on the scene graph, the audio descriptive information to obtain modified audio descriptive information, and
wherein the audio unit is configured to:
render, based on the modified audio descriptive information, the at least one audio element to one or more speaker feeds; and
output the one or more speaker feeds.

2. The device of claim 1,
wherein the scene manager is further configured to obtain at least one visual element, and
wherein the scene manager is configured to construct, based on the at least one audio element and the at least one visual element, the scene graph that includes a parent node representative of the at least one visual element, and a child node that depends from the parent node and that represents the at least one audio element.

3. The device of claim 2, wherein the scene manager is configured to align the at least one visual element and the at least one audio element when constructing the scene graph.

4. The device of claim 1, wherein the scene manager is further configured to update the scene graph to add, remove, or edit the at least one node that represents the at least one audio element.

5. The device of claim 2, wherein the scene manager is further configured to map, based on visual descriptive information associated with the at least one visual element and the audio descriptive information associated with the at least one audio element, the at least one visual element to the at least one audio element.

6. The device of claim 5,
wherein the visual descriptive information includes a position of the at least one visual element in the extended reality scene,
wherein the audio descriptive information includes a position of the at least one audio element in the extended reality scene, and
wherein the scene manager is configured to modify, based on the position of the at least one visual element, the position of the at least one audio element to obtain to obtain a modified position of the at least one audio element in the extended reality scene.

7. The device of claim 6, wherein the modified position of the at least one audio element differs from the position of the at least one audio element.

8. The device of claim 6, wherein the modified position of the at least one audio element differs from the position of the at least one audio element in terms of a rotational angle.

9. The device of claim 6, wherein the modified position of the at least one audio element differs from the position of the at least one audio element in terms of a translational distance.

10. The device of claim 5,
wherein the at least one audio element includes a first audio element and a second audio element,
wherein the scene manager is further configured to:
map, based on visual descriptive information associated with the at least one visual element and audio descriptive information associated with the first audio element, the at least one visual element to the first audio element;
determine that none of the at least one visual element maps to the second audio element; and
render, based on the audio descriptive information associated with the second audio element, the second audio element to the one or more speaker feeds.

11. The device of claim 5,
wherein the visual descriptive information includes an identifier that uniquely identifies the at least one visual element,
wherein the audio descriptive information includes an identifier that uniquely identifies the at least one audio element, and
wherein the scene manager is configured to map, based on the identifier that uniquely identifies the at least one visual element and the identifier that uniquely identifies the at least one audio element, the at least one visual element to the at least one audio element.

12. The device of claim 11,
wherein the identifier that uniquely identifies the at least one visual element includes one or more of a visual element identifier and a visual element name, and
wherein the identifier that uniquely identifies the at least one audio element includes one or more of an audio element identifier and an audio element name.

13. The device of claim 5, further comprising one or more speakers configured to reproduce, based on the one or more speaker feeds, a soundfield.

14. The device of claim 5, wherein the scene manager is further configured to output the modified audio descriptive information to the audio unit.

15. The device of claim 5, wherein the scene manager is further configured to output, via an application programming interface exposed by the audio unit, the modified audio descriptive information to the audio unit.

16. The device of claim 1, wherein the bitstream is transmitted according to one or more of a wireless network protocol, a personal area network protocol, and a cellular network protocol.

17. A method comprising:
obtaining a bitstream representative of at least one audio element in an extended reality scene, and audio descriptive information associated with the at least one audio element;
constructing, based on the at least one audio element, a scene graph that includes at least one node that represents the at least one audio element;
modifying, based on the scene graph, the audio descriptive information to obtain modified audio descriptive information;
rendering, based on the modified audio descriptive information, the at least one audio element to one or more speaker feeds; and
outputting the one or more speaker feeds.

18. The method of claim 17, further comprising obtaining at least one visual element,
wherein constructing the scene graph includes constructing, based on the at least one audio element and the at least one visual element, the scene graph that includes a parent node representative of the at least one visual element, and a child node that depends from the parent node and that represents the at least one audio element.

19. The method of claim 18, wherein constructing the scene graph includes aligning the at least one visual element and the at least one audio element.

20. The method of claim 18, further comprising mapping, based on visual descriptive information associated with the at least one visual element and the audio descriptive information associated with the at least one audio element, the at least one visual element to the at least one audio element.

21. The method of claim 20,
wherein the visual descriptive information includes a position of the at least one visual element in the extended reality scene,
wherein the audio descriptive information includes a position of the at least one audio element in the extended reality scene, and
wherein modifying the audio descriptive information comprises modifying, based on the position of the at least one visual element, the position of the at least one audio element to obtain to obtain a modified position of the at least one audio element in the extended reality scene.

22. The method of claim 21, wherein the modified position of the at least one audio element differs from the position of the at least one audio element.

23. The method of claim 21, wherein the modified position of the at least one audio element differs from the position of the at least one audio element in terms of a rotational angle.

24. The method of claim 21, wherein the modified position of the at least one audio element differs from the position of the at least one audio element in terms of a translational distance.

25. The method of claim 20,
wherein the at least one audio element includes a first audio element and a second audio element, and
wherein the method further comprises:
mapping, based on visual descriptive information associated with the at least one visual element and audio descriptive information associated with the first audio element, the at least one visual element to the first audio element;
determining that none of the at least one visual element maps to the second audio element; and
rendering, based on the audio descriptive information associated with the second audio element, the second audio element to the one or more speaker feeds.

26. The method of claim 20,
wherein the visual descriptive information includes an identifier that uniquely identifies the at least one visual element,
wherein the audio descriptive information includes an identifier that uniquely identifies the at least one audio element, and
wherein mapping the at least one visual element to the at least one audio element comprises mapping, based on the identifier that uniquely identifies the at least one visual element and the identifier that uniquely identifies the at least one audio element, the at least one visual element to the at least one audio element.

27. The method of claim 26,
wherein the identifier that uniquely identifies the at least one visual element includes one or more of a visual element identifier and a visual element name, and
wherein the identifier that uniquely identifies the at least one audio element includes one or more of an audio element identifier and an audio element name.

28. The method of claim 20, further comprising outputting, via an application programming interface exposed by an audio unit, the modified audio metadata to the audio unit.

29. The method of claim 20, wherein the bitstream is transmitted according to one or more of a wireless network protocol, a personal area network protocol, and a cellular network protocol.

30. A non-transitory computer-readable medium having stored thereon instructions that, when executed, cause processing circuitry to:
obtain a bitstream representative of at least one audio element in an extended reality scene, and audio descriptive information associated with the at least one audio element; and
construct, based on the at least one audio element, a scene graph that includes at least one node that represents the at least one audio element; and
modify, based on the scene graph, the audio descriptive information to obtain modified audio descriptive information, and
render, based on the modified audio descriptive information, the at least one audio element to one or more speaker feeds; and
output the one or more speaker feeds.
